(19) United States
(12) Patent Application Publication
(10) Pub. No.: US 2020/0309636 A1
(43) Pub. Date: Oct. 1, 2020

(54) STATE DETECTION APPARATUS, STATE DETECTION METHOD, AND ARCHITECTURE DIAGNOSIS APPARATUS

(71) Applicant: Panasonic Intellectual Property Management Co., Ltd., Osaka (JP)

(72) Inventors: Junya TANAKA, Osaka (JP); Taichi NAKAMURA, Osaka (JP); Masanori MINAMIO, Kanagawa (JP); Daido KOMYOJI, Nara (JP)

(21) Appl. No.: 16/794,432

(22) Filed: Feb. 19, 2020

(30) Foreign Application Priority Data
Mar. 27, 2019 (JP) 2019-061435
Apr. 10, 2019 (JP) 2019-074605
May 15, 2019 (JP) 2019-092139

(51) Int. Cl. G01M 7/02; H02N 2/18

(52) U.S. Cl. CPC G01M 7/025; H02N 2/186

(57) ABSTRACT

A state detection apparatus includes a state detection sensor that is attached to an architecture and that detects a state of the architecture, a power supp that generates power on the basis of vibration of the architecture, and a controller that controls the state detection sensor and the power supp. The controller supplies power to the state detection sensor to drive the state detection sensor in a case where a voltage by power generation exceeds a first threshold (threshold voltage), and acquires state information to be used for diagnosing the state of the architecture on the basis of a signal indicating a detection result received from the state detection sensor.

### CROSS REFERENCE TO RELATED APPLICATIONS

This application is entitled to and claims the benefit of Japanese Patent Applications No. 2019-092139, filed on May 15, 2019, No. 2019-061435, filed on Mar. 27, 2019, and No. 2019-074605, filed on Apr. 10, 2019, the disclosure of which including the specifications, drawings and abstracts are incorporated herein by reference in their entirety.

### TECHNICAL FIELD

The present disclosure relates to a state detection apparatus, a state detection method, and an architecture diagnosis apparatus.

### BACKGROUND ART

Conventional, an apparatus has been known which receives information indicating a sensing result from a state detection sensor which senses a state of an architecture (such as, for example, a bridge and a building) and diagnoses a state of the architecture on the basis of the information (see, for example, PTL 1).

The apparatus in PTL 1 supplies power to the state detection sensor when an amount of change in a temperature of the architecture or an ambient temperature exceeds a threshold, without uninterrupted supping power to the state detection sensor, to suppress power consumption. Further, the state detection sensor senses the state of the architecture using the supplied power.

### CITATION LIST

### Patent Literature

PTL 1
Japanese Patent Application Laid-Open No. 2016-57102

### SUMMARY OF INVENTION

### Technical Problem

However, the apparatus in PTL 1 is not suitable for monitoring an architecture to which great external force is temporarily applied. While examples of such an architecture can include, for example, a bridge on which a vehicle, or the like, travels (such as, for example, a road bridge and a railroad bridge), the bridge is less affected by an amount of change in the temperature. Therefore, it is impossible to appropriate diagnose the state of the bridge (such as, for example, a state of damage, or the like) even with a result of sensing performed on the basis of the amount of change in the temperature.

An object of one aspect of the present disclosure is to provide a state detection apparatus which can suppress power consumption and which can contribute to realization of an appropriate diagnosis of a state of an architecture, a state detection method, and an architecture diagnosis apparatus.

### Solution to Problem

A state detection apparatus according to one aspect of the present disclosure includes: a state detection sensor that is attached to an architecture and that detects a state of the architecture; a power supp that generates power on a basis of vibration of the architecture; and a controller that controls the state detection sensor and the power supp, in which the controller supplies power to the state detection sensor to drive the state detection sensor in a case where a voltage by the power generation exceeds a first threshold, and the controller acquires state information to be used for diagnosing the state of the architecture on a basis of a signal indicating a detection result received from the state detection sensor.

A state detection method according to another aspect of the present disclosure is a method to be performed by an apparatus including a state detection sensor that is attached to an architecture and that detects a state of the architecture, and a power supp that generates power on a basis of vibration of the architecture, the method including: supping power to the state detection sensor to drive the state detection sensor, in a case where a voltage by the power generation exceeds a first threshold; and acquiring state information to be used for diagnosing the state of the architecture on a basis of a signal indicating a detection result received from the state detection sensor.

An architecture diagnosis apparatus according to another aspect of the present disclosure includes a state detection apparatus and a diagnosis apparatus. The state detection apparatus comprises a state detection sensor that is attached to an architecture and that detects a state of the architecture, a power supp that generates power on a basis of vibration of the architecture, and a controller that controls the state detection sensor and the power supp. The controller supplies power to the state detection sensor to drive the state detection sensor in a case where a voltage by the power generation exceeds a first threshold and acquires state information to be used for diagnosing the state of the architecture on a basis of a signal indicating a detection result received from the state detection sensor. The diagnosis apparatus diagnoses the state of the architecture on a basis of information from the state detection apparatus.

### Advantageous Effects of Invention

According to the present disclosure, it is possible to suppress power consumption and contribute to realization of an appropriate diagnosis of a state of an architecture.

### BRIEF DESCRIPTION OF DRAWINGS

FIG. 1 is a pattern diagram illustrating a configuration of an architecture diagnosis apparatus according to Embodiment 1 of the present disclosure;

FIG. 2 is a block diagram illustrating main components of a state detection apparatus according to Embodiment 1 of the present disclosure;

FIG. 3 is a block diagram illustrating main components of a diagnosis apparatus according to Embodiment 1 of the present disclosure;

FIG. 4 is a graph illustrating a timing for the state detection apparatus according to Embodiment 1 of the present disclosure to detect a state of a road bridge;

FIG. 5 is a flowchart illustrating an example of entire operation of the state detection apparatus according to Embodiment 1 of the present disclosure;

FIG. 6 is a graph illustrating a detection signal detected by a state detection sensor according to Embodiment 1 of the present disclosure;

FIG. 7 is a flowchart illustrating an example of operation in which the state detection apparatus according to Embodiment 1 of the present disclosure transmits state information;

FIG. 8 is a schematic diagram illustrating an overall configuration of a diagnosis apparatus of a road bridge which is an example of Embodiment 2 of the present disclosure;

FIG. 9 is a block diagram illustrating a configuration of main components of a state detection apparatus according to Embodiment 2 of the present disclosure;

FIG. 10 is a block diagram illustrating a configuration of main components of a diagnosis section according to Embodiment 2 of the present disclosure;

FIG. 11 is a graph illustrating a timing for the state detection apparatus according to Embodiment 2 of the present disclosure to detect a state;

FIG. 12 is a flowchart illustrating an example of operation of the state detection apparatus according to Embodiment 2 of the present disclosure;

FIG. 13 is a flowchart illustrating an example of operation in which the state detection apparatus according to Embodiment 2 of the present disclosure acquires state information;

FIG. 14 is a flowchart illustrating an example of operation in which the state detection apparatus according to Embodiment 2 of the present disclosure transmits state information;

FIG. 15 is a schematic configuration diagram in a case where an architecture diagnosis apparatus according to Embodiment 3 of the present disclosure is used for measuring vibration to estimate degradation of a railroad bridge;

FIG. 16 is a configuration diagram of a state detection apparatus according to Embodiment 3 of the present disclosure;

FIG. 17 is a perspective view of a vibration power generating element according to Embodiment 3 of the present disclosure;

FIG. 18 is a schematic voltage waveform diagram of the vibration power generating element in a case where a train travels on a bridge in the architecture diagnosis apparatus according to Embodiment 3 of the present disclosure;

FIG. 19 is a configuration diagram of a data collecting apparatus according to Embodiment 3 of the present disclosure;

FIG. 20 illustrates a configuration of a diagnosis apparatus according to Embodiment 3 of the present disclosure;

FIG. 21 is a schematic configuration diagram in a case where an architecture diagnosis apparatus according to Embodiment 4 of the present disclosure is used for measuring vibration to estimate degradation of a lower structure of an expressway which is an architecture;

FIG. 22 is a configuration diagram of a state detection apparatus according to Embodiment 4 of the present disclosure;

FIG. 23 illustrates a configuration of a state detection apparatus to be used for an architecture diagnosis apparatus according to Embodiment 5 of the present disclosure; and

FIG. 24 illustrates a configuration where the state detection apparatus is provided at an expressway in the architecture diagnosis apparatus according to Embodiment 5 of the present disclosure.

### DESCRIPTION OF EMBODIMENTS

Embodiment 1 to Embodiment 5 of the present disclosure will be described below with reference to the accompanying drawings. Note that the same reference numerals will be assigned to components common in the respective drawings, and description thereof will be omitted as appropriate.

### Embodiment 1

<Architecture Diagnosis Apparatus 100>

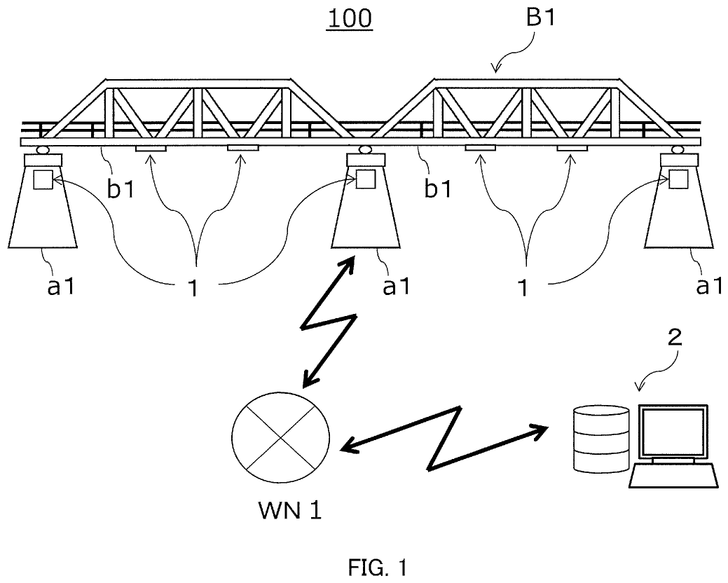

An overall configuration of architecture diagnosis apparatus 100 according to the present embodiment will be described using FIG. 1. FIG. 1 is a pattern diagram illustrating the overall configuration of architecture diagnosis apparatus 100 of the present embodiment.

In the present embodiment, description will be provided using an example in a case where an architecture whose state is diagnosed by architecture diagnosis apparatus 100 is road bridge B1. The state of road bridge B1 refers to, for example, a level of erosion, corrosion and damage by external force such as an earthquake, of road bridge B1.

Note that an architecture to be diagnosed is not limited to road bridge B1, and may be, for example, a railroad bridge on which a train travels, a tunnel through which a vehicle passes, a storage dam, or the like.

As illustrated in FIG. 1, architecture diagnosis apparatus 100 includes a plurality of state detection apparatuses 1 and diagnosis apparatus 2. Each state detection apparatus 1 is connected to diagnosis apparatus 2 via wireless network WN1.

State detection apparatuses 1 are, for example, attached to bridge pier a1 and bridge beam b1 of road bridge B1. Bridge pier a1 is a portion which supports an upper structure of road bridge B1. Bridge beam b1 is a plate-like portion built between bridge piers a1.

Note that state detection apparatus 1 may be attached to a portion other than bridge pier a1 and bridge beam b1. Further, while, in the present embodiment, description will be provided using an example in a case where a plurality of state detection apparatuses 1 are attached to road bridge B1, the number of state detection apparatuses 1 to be attached to road bridge B1 may be one. In this case, state detection apparatus 1 may be attached to, for example, bridge pier a1 of road bridge B1.

Diagnosis apparatus 2 is an information processing apparatus such as, for example, a server and a personal computer. Diagnosis apparatus 2 is provided at, for example, an administration office, an administration center, or the like.

While details will be described later, diagnosis apparatus 2 receives state information from each state detection apparatus 1 via wireless network WN1, and diagnoses a state of road bridge B1 on the basis of the state information and parameters determined in advance.

<State Detection Apparatus 1>

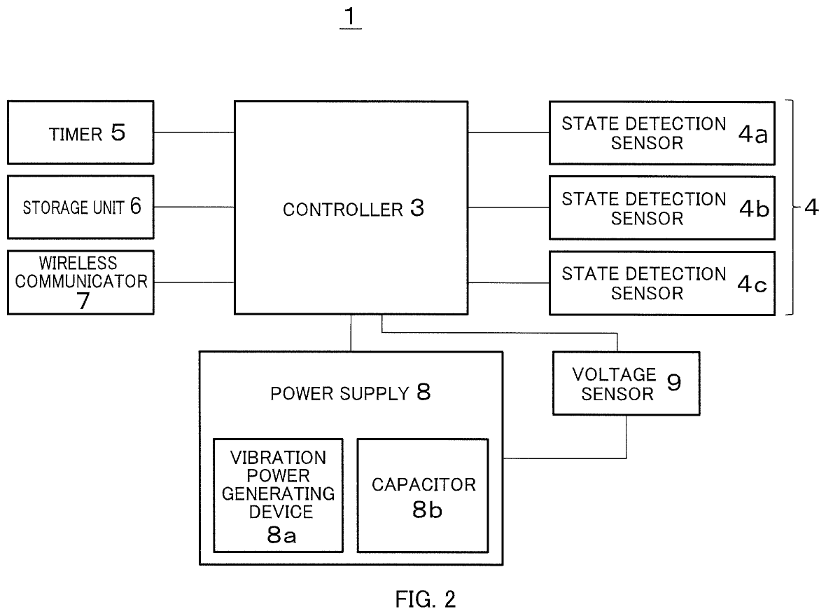

A configuration of state detection apparatus 1 will be described using FIG. 2. FIG. 2 is a block diagram illustrating main components of state detection apparatus 1.

As illustrated in FIG. 2, state detection apparatus 1 includes controller 3, state detection sensor group 4, timer 5, storage unit 6, wireless communicator 7, power supp 8, and voltage sensor 9. State detection sensor group 4 includes three state detection sensors 4a, 4b and 4c.

These components may be made up of hardware or may be made up of software.

<Controller 3>

Controller 3 is electrical connected to state detection sensor group 4, timer 5, storage unit 6, wireless communicator 7, power supp 8 and voltage sensor 9, and controls operation of these components.

While illustration will be omitted, controller 3 includes a power supp circuit and a processing circuit. The power supp circuit is a circuit which supplies power to state detection sensors 4a, 4b and 4c. Further, the processing circuit is a circuit which acquires state information (which will be described in detail later) by processing detection signals received from state detection sensors 4a, 4b and 4c.

Further, controller 3 performs various kinds of determination processing. Details of various kinds of determination processing will be described later.

Typical, an electronic apparatus has a sleep mode in which power is saved while a power-on state is maintained. Further, state detection apparatus 1 of the present embodiment also has the sleep mode. Controller 3 performs control to put state detection apparatus 1 into the sleep mode. In the sleep mode, power is not supplied to, for example state detection sensor group 4, storage unit 6, and wireless communicator 7 by control by controller 3. State detection apparatus 1 is normal in the sleep mode.

<State Detection Sensors 4a, 4b and 4c>

State detection sensors 4a, 4b and 4c are, for example, attached to a chassis (not illustrated) of state detection apparatus 1.

Note that state detection sensors 4a, 4b and 4c may be direct attached to road bridge B1 (for example, bridge pier a1, bridge beam b1 or other portions). However, because controller 3 cannot read detection signals from state detection sensors 4a, 4b and 4c in a case where the detection signals are weak, state detection sensors 4a, 4b and 4c are preferably attached near state detection apparatus 1 so that attenuation of the detection signals becomes as little as possible.

As state detection sensors 4a, 4b and 4c, for example, an acceleration sensor, a displacement sensor, or an inclination sensor can be used.

The acceleration sensor detects acceleration of vibration of the attached position. The displacement sensor detects an amount of displacement of road bridge B1 (for example, a distance between bridge piers a1, or a distance between bridge beam b1 and bridge pier a1) at the attached position. The inclination sensor detects an inclination angle of road bridge B1 at the attached position.

State detection sensors 4a, 4b and 4c may be all the same types of sensors, or may be different kinds of sensors.

Note that a state of the architecture such as road bridge B1 changes by season, weather, or the like. Therefore, one of state detection sensors 4a, 4b and 4c may be a sensor (such as, for example, a thermo-hygro sensor) other than the above-described three types of sensors. For example, it is possible to realize state detection with higher accuracy by using the thermo-hygro sensor and the acceleration sensor in combination.

State detection sensors 4a, 4b and 4c respective transmit detection signals indicating detection results, to controller 3.

<Timer 5>

Timer 5 measures current date and time.

<Storage Unit 6>

Storage unit 6 stores various kinds of setting parameters to be used upon operation of state detection apparatus 1.

Examples of the setting parameters can include, for example, a timing for storing state information which will be described later, a timing for transmitting state information, a threshold voltage, the number of times of execution of state detection, or the like.

Further, storage unit 6 temporarily stores state information acquired by controller 3 on the basis of the detection signals from state detection sensors 4a, 4b and 4c.

<Wireless Communicator 7>

Wireless communicator 7 controls wireless communication between state detection apparatus 1 and diagnosis apparatus 2.

<Power Supp 8>

Power supp 8 includes vibration power generating device 8a and capacitor 8b. Vibration power generating device 8a and capacitor 8b are drive power supplies of state detection apparatus 1.

Power supp 8 supplies power required for operation of each component of state detection apparatus 1 to each component of state detection apparatus 1 from capacitor 8b via controller 3. By this means, state detection sensors 4a, 4b and 4c, timer 5, storage unit 6, wireless communicator 7 and voltage sensor 9 operate.

<Vibration Power Generating Device 8a>

Vibration power generating device 8a generates power through vibration of road bridge B1 (for example, vibration occurring when a vehicle travels on road bridge B1). The power generated by vibration is supplied to capacitor 8b. By this means, it is possible to charge capacitor 8b in accordance with occurrence of vibration. It is therefore possible to realize longer life of capacitor 8b and state detection apparatus 1.

Power generated by vibration and output from vibration power generating device 8a is AC power. To accumulate the power in capacitor 8b, it is necessary to convert AC power into DC power. Therefore, while illustration will be omitted, a conversion circuit which converts AC power into DC power is provided between vibration power generating device 8a and capacitor 8b.

Further, vibration power generating device 8a uses magnetostrictive vibration power generation. The magnetostrictive vibration power generation has characteristics of little loss upon charging of capacitor 8b and being excellent in a power generation amount because its voltage is relative low and its resistance is low.

<Voltage Sensor 9>

Voltage sensor 9 is connected to vibration power generating device 8a. Voltage sensor 9 detects a voltage of power generated by vibration power generating device 8a (hereinafter, also referred to as a voltage of power generation).

A factor which affects damage of road bridge B1 most is, for example, external force applied when a vehicle enters road bridge B1 and when a vehicle passes through road bridge B1. When large external force is applied to road bridge B1, road bridge B1 further vibrates, and a power generation amount of vibration power generating device 8a increases.

Correlation is acknowledged between a change in voltage detected by voltage sensor 9 and temporal change of the power generation amount of vibration power generating device 8a. That is, correlation is acknowledged such that when a power generation amount of vibration power generating device 8a increases, the voltage detected by voltage sensor 9 also increases.

<Diagnosis Apparatus 2>

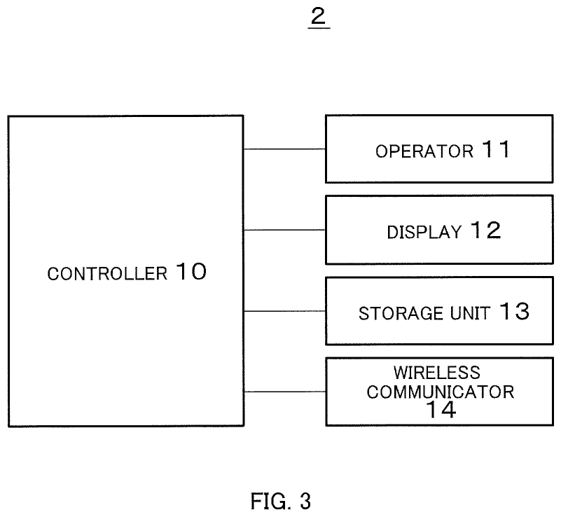

A configuration of diagnosis apparatus 2 will be described using FIG. 3. FIG. 3 is a block diagram illustrating main components of diagnosis apparatus 2.

Diagnosis apparatus 2 includes controller 10, operator 11, display 12, storage unit 13 and wireless communicator 14.

Diagnosis apparatus 2 is, for example, connected to a commercial power supp. Further, as described above, diagnosis apparatus 2 is, for example, an information processing apparatus such as a typical personal computer and a server.

<Controller 10>

Controller 10 controls operation of each component of diagnosis apparatus 2. Further, controller 10 diagnoses a state of road bridge B1 on the basis of the state information received from state detection apparatus 1 and parameters determined in advance.

In a case where the state information is acquired on the basis of the detection signal of the acceleration sensor (acceleration detection signal), diagnosis apparatus 2 diagnoses the state of road bridge B1 on the basis of a parameter corresponding to the state information of the acceleration sensor.

In a case where the state information is acquired on the basis of the detection signal of the displacement sensor (displacement amount detection signal), diagnosis apparatus 2 diagnoses the state of road bridge B1 on the basis of a parameter corresponding to the state information of the displacement sensor.

In a case where the state information is acquired on the basis of the detection signal of the inclination sensor (inclination angle detection signal), diagnosis apparatus 2 diagnoses the state of road bridge B1 on the basis of a parameter corresponding to the state information of the inclination sensor.

<Operator 11>

Operator 11 accepts various kinds of input operation performed by a user of diagnosis apparatus 2. Operator 11 is, for example, an input device such as a keyboard and a mouse.

<Display 12>

Display 12 displays various kinds of information on a screen. Specifically, display 12 displays a screen in accordance with input operation accepted by operator 11 or displays a screen in accordance with a result of processing executed by controller 10 (for example, a result of processing of comparison with various kinds of parameters). Display 12 is, for example, a display device such as a display.

<Storage Unit 13>

Storage unit 13 stores parameters to be used upon operation of diagnosis apparatus 2 and the state information received from state detection apparatus 1.

<Wireless Communicator 14>

Wireless communicator 14 controls wireless communication with each state detection apparatus 1 attached to road bridge B1. For example, wireless communicator 14 receives the state information transmitted from state detection apparatus 1 via wireless network WN1.

<Detection Timing of State of Road Bridge B1 by State Detection Apparatus 1>

A timing for state detection apparatus 1 to detect the state of road bridge B1 will be described.

Controller 3 transmits an execution instruction (hereinafter, referred to as a detection instruction) to detect the state of road bridge B1 to state detection sensors 4a, 4b and 4c. Upon receipt of the detection instruction, state detection sensors 4a, 4b and 4c detect the state of road bridge B1 and transmit detection signals to controller 3.

Controller 3 acquires state information on the basis of the detection signals and causes the state information to be stored in storage unit 6.

A frequency of the detection instruction transmitted from controller 3 to state detection sensors 4a, 4b and 4c (hereinafter, simply referred to as a “frequency of a detection instruction”) is determined by setting of a threshold voltage, the number of times of detection and a period which will be described later. To suppress power consumption of state detection apparatus 1, it is preferable to make a frequency of the detection instruction as low as possible. Therefore, a frequency of the detection instruction per day is preferably set, for example, equal to or less than four times or equal to or less than three times.

Meanwhile, when controller 3 does not receive detection signals for a long period, controller 3 cannot acquire state information. As a result, it is not preferable that a period during which diagnosis apparatus 2 cannot diagnose a state of the road becomes long. Therefore, to appropriate diagnose the state of road bridge B1, a frequency of the detection instruction is preferably set to, for example, once every two days or equal to or greater than once every three days.

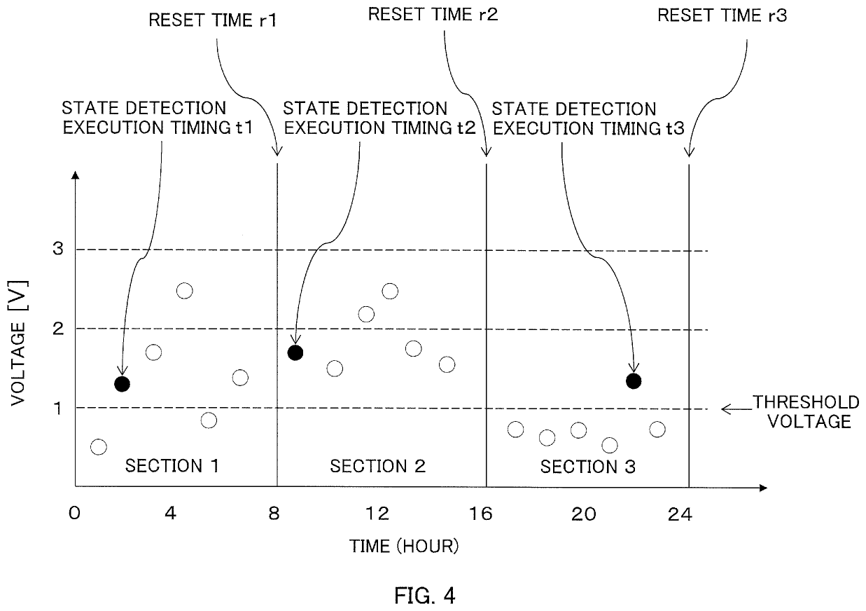

Here, a specific example of a timing for state detection apparatus 1 to detect the state of road bridge B1 will be described using FIG. 4. FIG. 4 is a graph illustrating a timing for state detection apparatus 1 to detect the state of road bridge B1. FIG. 4 indicates a voltage detected by voltage sensor 9 (that is, a voltage of power generation of vibration power generating device 8a) on a vertical axis. FIG. 4 indicates time of one day on a horizontal axis.

Here, a case will be described where state detection sensors 4a, 4b and 4c detect the state of road bridge B1 three times a day. In the present embodiment, as illustrated in FIG. 4, hours of the day (24 hours) are divided into three time slots of sections 1 to 3. Section 1 is from 0:00 to 8:00, section 2 is from 8:00 to 16:00, and section 3 is from 16:00 to 24:00. Further, state detection sensors 4a, 4b and 4c are driven once in each of sections 1 to 3 to detect the state of road bridge B1.

<Threshold Voltage>

A threshold voltage to be used by controller 3 will be described. The threshold voltage corresponds to an example of a first threshold.

The threshold voltage is a parameter which is used by controller 3 to determine whether or not it is a timing for driving state detection sensors 4a, 4b and 4c. The threshold voltage is stored in storage unit 6. Further, the threshold voltage is, for example, 1 V.

Controller 3 compares the voltage of power generation detected by voltage sensor 9 with the threshold voltage, and, in a case where the voltage of power generation is greater than the threshold voltage, determines that it is a timing for driving state detection sensors 4a, 4b and 4c. In this case, controller 3 transmits the detection instruction to state detection sensors 4a, 4b and 4c.

<Transmission Timing of State Information>

A timing for state detection apparatus 1 to transmit the state information to diagnosis apparatus 2 will be described.

As illustrated in FIG. 1, a plurality of state detection apparatuses 1 are attached to road bridge B1. Therefore, in a case where the plurality of state detection apparatuses 1 transmit the state information to diagnosis apparatus 2 at the same time using the same channel, there is a possibility that respective pieces of state information may collide, and a communication error may occur.

Therefore, in the present embodiment, timings for state detection apparatuses 1 to transmit the respective pieces of state information are set so as to be different from each other. By this means, it is possible to prevent the plurality of state detection apparatuses 1 from transmitting the state information at the same time.

<Entire Operation of State Detection Apparatus 1>

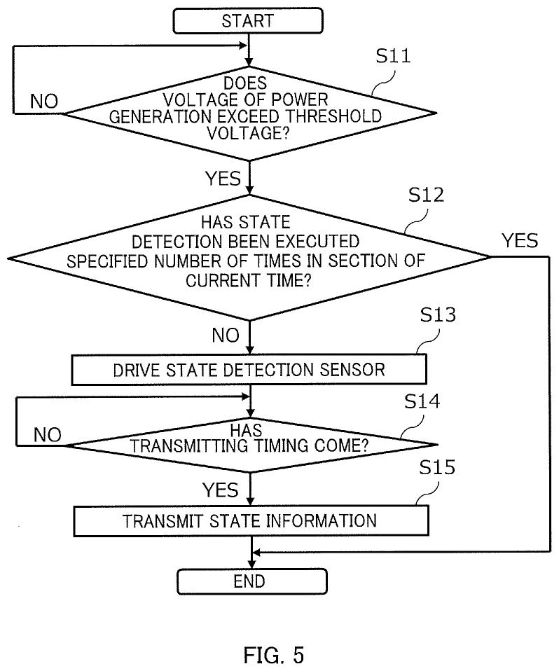

Entire operation of state detection apparatus 1 will be described using FIG. 5. FIG. 5 is a flowchart illustrating an example of the entire operation of state detection apparatus 1. Flow in FIG. 5 is started when state detection apparatus 1 is in a sleep mode.

First, controller 3 determines whether or not the voltage of power generation of vibration power generating device 8a detected by voltage sensor 9 exceeds the threshold voltage (step S11).

In a case where the voltage of power generation does not exceed the threshold voltage (step S11: No), the flow returns to step S11.

Meanwhile, in a case where the voltage of power generation exceeds the threshold voltage (step S11: Yes), the flow proceeds to step S12.

Then, in a section of current time, controller 3 determines whether or not state detection has been executed a specified number of times by state detection sensors 4a, 4b and 4c (step S12).

For example, it is assumed that current time measured by timer 5 is 4:00, and a section of the current time is section 1 illustrated in FIG. 4. Further, in section 1, it is assumed that the specified number of times of state detection is set to one. In this case, controller 3 determines that state detection has been executed the specified number of times when controller 3 receives detection signals from state detection sensors 4a, 4b and 4c once from 0:00 to 4:00. Meanwhile, controller 3 determines that state detection has not been executed the specified number of times when controller 3 does not receive detection signals from state detection sensors 4a, 4b and 4c from 0:00 to 4:00 even once.

In a case where state detection has been executed the specified number of times in the section of current time (step S12: Yes), the flow ends.

Meanwhile, in a case where state detection has not been executed the specified number of times in the section of the current time (step S12: No), the flow proceeds to step S13.

Next, controller 3 drives state detection sensors 4a, 4b and 4c (step S13).

Specifically, controller 3 controls power supp 8 so that power is supplied to state detection sensors 4a, 4b and 4c from capacitor 8b, and transmits the detection instruction to state detection sensors 4a, 4b and 4c. By this means, state detection sensors 4a, 4b and 4c detect the state of road bridge B1 and transmits detection signals to controller 3. Controller 3 processes the detection signals to acquire state information, and causes the state info nation to be stored in storage unit 6.

Next, controller 3 determines whether or not a transmission timing of the state information has come (step S14).

Specifically, controller 3 determines whether or not a transmission timing of the state information determined in advance has come on the basis of the current time measured by timer 5. Note that, as described above, the transmission timing of the state information is set so as to be different for each state detection apparatus 1.

In a case where the transmission timing of the state information has not come (step S14: No), the flow returns to step S14.

In a case where the transmission timing of the state information has come (step S14: Yes), the flow proceeds to step S15.

Next, controller 3 controls power supp 8 so that power is supplied to storage unit 6 and wireless communicator 7 from capacitor 8b. Then, controller 3 reads out the state information from storage unit 6, transmits the state information to wireless communicator 7, and instructs wireless communicator 7 to transmit the state information. By this means, wireless communicator 7 transmits the state information received from controller 3 to diagnosis apparatus 2 (step S15).

As described above, while the acceleration sensor and the displacement sensor can be used to detect the state of road bridge B1, in a case where road bridge B1 is not vibrating, because detection signals are not output, the state information is not acquired, and, as a result, the state of road bridge B1 cannot be diagnosed. That is, it is effective in terms of power consumption to acquire the state information from the detection signals by driving state detection sensors 4a, 4b and 4c while road bridge B1 is vibrating, while putting state detection apparatus 1 into a sleep mode while road bridge B1 is not vibrating.

Here, the above-described operation of state detection apparatus 1 will be supplemented using FIG. 4.

In FIG. 4, state detection execution timings t1, t2 and t3 (see black circles in FIG. 4) are timings at which the voltage detected by voltage sensor 9 exceeds the threshold voltage. Controller 3 supplies power to state detection sensors 4a, 4b and 4c to drive state detection sensors 4a, 4b and 4c during a period determined in advance (hereinafter, referred to as a specified period) from state detection execution timings t1, t2 and t3. The specified period is a period during which state detection is executed once, and, for example, 60 seconds.

For example, in section 1, during the specified period from state detection timing t1, state detection sensors 4a, 4b and 4c detect the state of road bridge B1. When controller 3 receives the detection signals from state detection sensors 4a, 4b and 4c, controller 3 stores the number of times of executed state detection of “1” and determines that the specified number of times in section 1 of “1” is satisfied. Then, after the specified period has elapsed, controller 3 puts state detection apparatus 1 into the sleep mode. Thereafter, even when the voltage detected by voltage sensor 9 exceeds the threshold voltage during section 1, controller 3 does not drive state detection sensors 4a, 4b and 4c.

Thereafter, when the current time measured by timer 5 reaches reset time r1 (for example, 8:00), the number of times of executed state detection of “1” in section 1 is reset.

The above-described operation is similarly performed also in sections 2 and 3 illustrated in FIG. 4.

<Example of Detection Signals>

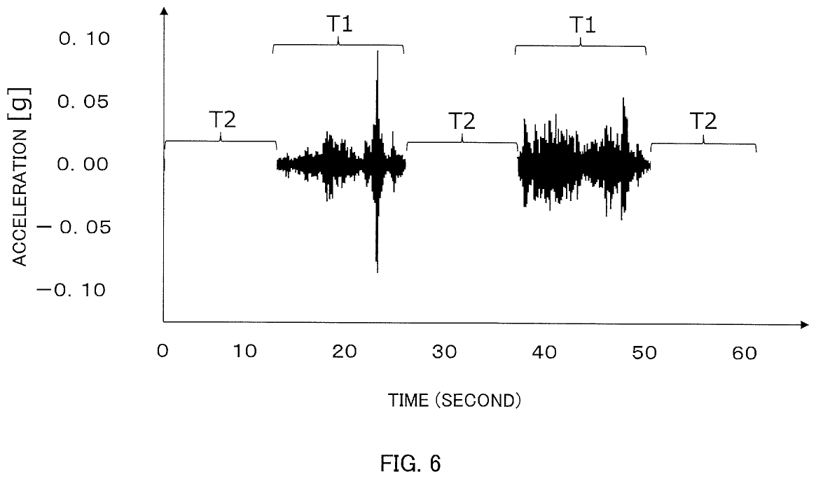

An example of the detection signals detected by state detection sensors 4a, 4b and 4c will be described using FIG. 6. Here, description will be provided using an example of a case where state detection sensors 4a, 4b and 4c are acceleration sensors.

FIG. 6 is a graph illustrating the detection signals detected by state detection sensors 4a, 4b and 4c during the specified period since the voltage detected by voltage sensor 9 has exceeded the threshold voltage. FIG. 6 indicates time on a horizontal axis and indicates acceleration on a vertical axis. Here, description will be provided using a case as an example where the specified period is set to 60 seconds.

As illustrated in FIG. 6, during 60 seconds which are a specified period, there exist time slot T1 in which large acceleration is detected (hereinafter, referred to as a first time slot), and time slot T2 in which acceleration is hard detected (hereinafter, referred to as a second time slot).

For example, first time slot T1 is a time slot in which the voltage detected by voltage sensor 9 is greater than a predetermined threshold, and second time slot T2 is a time slot in which the voltage detected by voltage sensor 9 is equal to or less than the predetermined threshold. The predetermined threshold is, for example, a value greater than the above-described threshold voltage (first threshold). Further, the predetermined threshold corresponds to an example of a second threshold.

In a case where road bridge B1 is diagnosed on the basis of the state information acquired from detection signals of acceleration, the state information acquired from the detection signals in second time slot T2 is not necessarily required. However, because the state information has a predetermined data amount, it takes a certain amount of communication period when the state information is transmitted from state detection apparatus 1 to diagnosis apparatus 2, and, therefore power consumption becomes large.

Therefore, controller 3 may acquire the state information on from the detection signals in first time slot T1 without acquiring the state information from the detection signals in second time slot T2. By this means, because on the state information acquired from the detection signals in first time slot T1 is transmitted to diagnosis apparatus 2, it is possible to reduce an amount of data to be communicated. As a result, it is possible to reduce power consumption at state detection apparatus 1.

Alternative, controller 3 may put state detection sensors 4a, 4b and 4c into a sleep state (state where a power supp amount is reduced) during second time slot T2. By this means, it is possible to reduce power consumption required for operation of state detection sensors 4a, 4b and 4c.

Determination as to whether or not to put state detection sensors 4a, 4b and 4c into the sleep state is made by controller 3 on the basis of the voltage detected by voltage sensor 9. For example, in a case where the voltage detected by voltage sensor 9 is equal to or less than the predetermined threshold while state detection sensors 4a, 4b and 4c are driven, controller 3 may reduce an amount of power supp to state detection sensors 4a, 4b and 4c and may put state detection sensors 4a, 4b and 4c into the sleep state.

It is difficult to predict when a vehicle travels on road bridge B1 and what kind of vehicles travels on road bridge B1. Therefore, the present embodiment is effective when state detection is performed through wireless communication while power consumption is reduced.

Note that parameters such as the above-described threshold voltage, sections and the specified number of times may be set to, for example, state detection apparatus 1 from diagnosis apparatus 2 via wireless communicator 7. At this time, controller 3 of state detection apparatus 1 may control power supp 8 so as to supp power to wireless communicator 7. By this means, it is possible to easily change various kinds of parameters using diagnosis apparatus 2.

<State Information Transmission Operation>

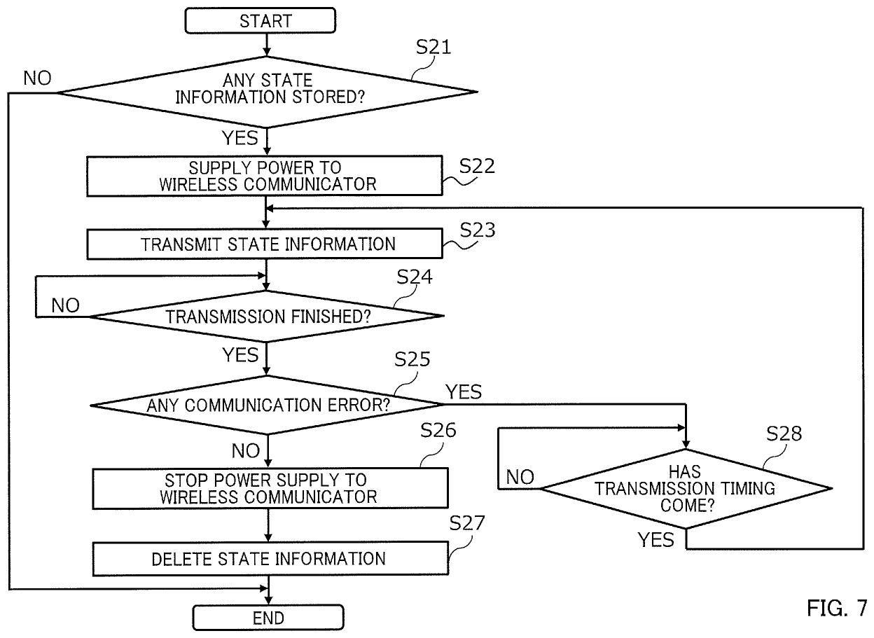

A specific example of operation (step S15 in FIG. 5) in which state detection apparatus 1 transmits the state information will be described using FIG. 7. FIG. 7 is a flowchart illustrating an example of operation in which state detection apparatus 1 transmits the state information.

First, controller 3 determines whether or not the state information is stored in storage unit 6 (step S21).

In a case where the state information is not stored in storage unit 6 (step S21: No), the flow ends.

Meanwhile, in a case where the state information is stored in storage unit 6 (step S21: Yes), the flow proceeds to step S22.

Next, controller 3 supplies power from capacitor 8b to wireless communicator 7 (step S22). Further, at this time, controller 3 supplies power from capacitor 8b to storage unit 6.

Next, controller 3 reads out the state information from storage unit 6, transmits the state information to wireless communicator 7 and instructs wireless communicator 7 to transmit the state information to diagnosis apparatus 2. By this means, wireless communicator 7 transmits the state information to diagnosis apparatus 2 via wireless network WN1 (step S23).

Next, controller 3 determines whether or not transmission of the state information is finished (step S24).

In a case where transmission of the state information is not finished (step S24: No), the flow returns to step S24.

Meanwhile, in a case where transmission of the state information is finished (step S24: Yes), the flow proceeds to step S25.

Next, controller 3 determines whether or not there is a communication error in transmission of the state information (step S25).

In a case where there is no communication error in transmission of the state information (step S25: No), that is, in a case where the state information is normal transmitted to diagnosis apparatus 2, the flow proceeds to step S26.

Next, controller 3 stops power supp to wireless communicator 7 (step S26).

Next, controller 3 deletes the state information which is transmitted to diagnosis apparatus 2 and which is stored in storage unit 6, from storage unit 6 (step S27).

Meanwhile, in a case where there is a communication error in transmission of the state information (step S25: Yes), the flow proceeds to step S28.

Controller 3 determines whether or not the next transmission timing has come to try transmission again (step S28). This determination processing is similar to that in the above-described step S14 in FIG. 5.

In a case where the transmission timing of the state information has not come (step S28: No), the flow returns to step S28.

Meanwhile, in a case where the transmission timing of the state information has come (step S28: Yes), the flow returns to step S23.

<Effects>

A state of an architecture such as road bridge B1 does not drastically change unless large external force (for example, external force by an earthquake) is applied. Therefore, state detection sensors 4a, 4b and 4c do not need to uninterrupted detect the state of road bridge B1. Therefore, state detection apparatus 1 of the present embodiment supplies power to state detection sensors 4a, 4b and 4c and detects the state of road bridge B1 in a case where the voltage of power generation of vibration power generating device 8a exceeds the threshold voltage. It is therefore possible to suppress power consumption of state detection apparatus 1.

Further, in the present embodiment, a case where the voltage of power generation of vibration power generating device 8a exceeds the threshold voltage is a case where there are a number of vehicles which travel on road bridge B1. In this case, state detection sensors 4a, 4b and 4c can appropriate detect the state of road bridge B1. Therefore, state detection apparatus 1 can obtain preferred detection signals by driving state detection sensors 4a, 4b and 4c and can acquire preferred state information based on the detection signals in a case where the voltage of power generation of vibration power generating device 8a exceeds the threshold voltage. According, state detection apparatus 1 can contribute to realization of appropriate diagnosis of the state of road bridge B1.

Further, because state detection apparatus 1 supplies power to storage unit 6 and wireless communicator 7 on when the state information is transmitted to diagnosis apparatus 2, it is possible to further suppress power consumption.

As described above, according to state detection apparatus 1 and architecture diagnosis apparatus 100 of the present embodiment, it is possible to suppress power consumption and contribute to realization of appropriate diagnosis of a state of an architecture.

### Second Embodiment

<Perspective>

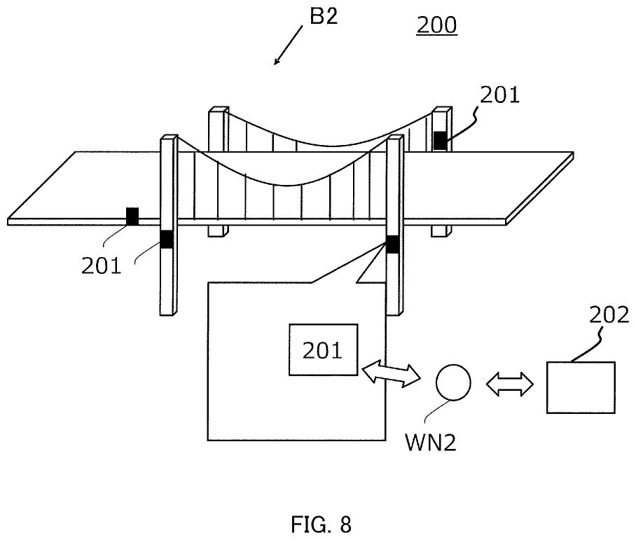

FIG. 8 illustrates an overall configuration of architecture diagnosis apparatus 200 which is an example of the present embodiment. In the present embodiment, description will be provided using road bridge B2 on which a vehicle travels as an example of the architecture. Architecture diagnosis apparatus 200 of the present embodiment diagnoses a state of road bridge B2. The state (of road bridge B2) refers to a level of erosion, corrosion and damage by external force such as an earthquake, (of road bridge B2). Note that the architecture is not limited to road bridge B2. The architecture may be, for example, a railroad bridge on which a train travels, a tunnel through which a vehicle passes, or a storage dam.

Architecture diagnosis apparatus 200 illustrated in FIG. 8 includes state detection apparatus 201 and diagnosis apparatus 202. State detection apparatus 201 is attached to, for example, a bridge pier of road bridge B2. The bridge pier refers to a portion which supports an upper structure of the bridge. Further, state detection apparatus 201 may be attached to, for example, a bridge beam of road bridge B2. The bridge beam refers to a plate-like portion which is built between the bridge pier and the bridge pier of road bridge B2. State detection apparatus 201 may be attached to a portion other than the bridge pier or the bridge beam of road bridge B2. Further, in the present embodiment, a plurality of state detection apparatuses 201 are attached to, for example, the bridge piers of road bridge B2. Note that one state detection apparatus 201 may be attached to, for example, the bridge pier.

Diagnosis apparatus 202 is, for example, an information processing apparatus constituted with a personal computer, and is provided at an administration office or an administration center. Further, state detection apparatus 201 can wireless communicate with diagnosis apparatus 202 via wireless network WN2. While details will be described later, diagnosis apparatus 202 diagnoses the state of road bridge B2 in accordance with parameters determined in advance on the basis of the state information from state detection apparatus 201. Note that state detection apparatus 201 may be able to perform wired communication with diagnosis apparatus 202 via a wired cable, or the like.

<State Detection Apparatus 201>

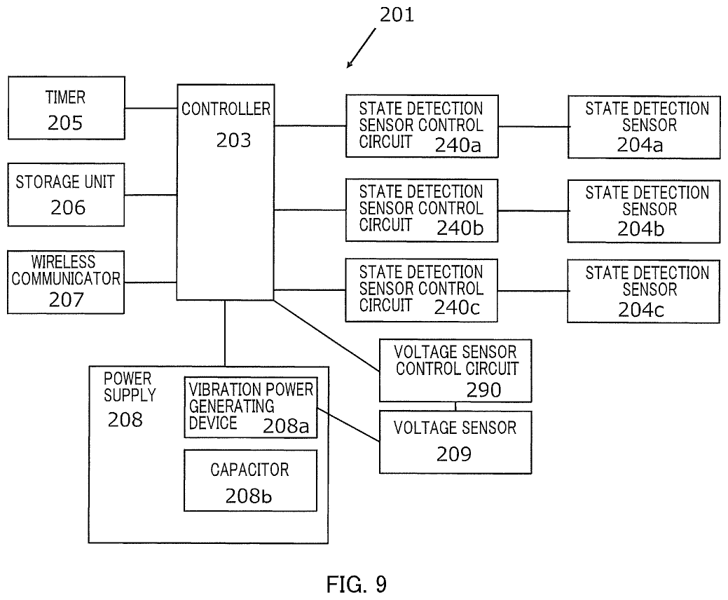

FIG. 9 is a block diagram illustrating a configuration of main components of state detection apparatus 201.

State detection apparatus 201 includes controller 203, three state detection sensors 204a, 204b and 204c, state detection sensor control circuits 240a, 240b and 240c, timer 205, storage unit 206, wireless communicator 207 and power supp 208. Note that, while, in the present embodiment, state detection sensor control circuits 240a, 240b and 240c, timer 205, storage unit 206, wireless communicator 207 and power supp 208 are provided outside of controller 203, they may be provided inside of controller 203. Further, in the present embodiment, these circuits and components may be constituted with software.

<State Detection Sensors 204a, 204b and 204c>

State detection sensors 204a, 204b and 204c are respective connected to state detection apparatus 201 via state detection sensor control circuits 240a, 240b and 240c which will be described later. State detection sensors 204a, 204b and 204c transmit detection signals to state detection sensor control circuits 240a, 240b and 240c which will be described later. State detection sensors 204a, 204b and 204c are attached to, for example, a chassis of state detection apparatus 201 attached to road bridge B2. Further, state detection sensors 204a, 204b and 204c may be direct attached to the bridge pier or the bridge beam of road bridge B2 or may be attached to a portion other than the bridge pier and the bridge beam. Note that, because state detection sensors 204a, 204b an 204c cannot read signals from state detection sensors 204a, 204b and 204c in a case where the signals are weak, state detection sensors 204a, 204b and 204c are preferably attached near state detection apparatus 201 to which state detection sensors 204a, 204b and 204c are connected so as to minimize attenuation. Further, as state detection sensors 204a, 204b and 204c, for example, acceleration sensors are used. The acceleration sensors detect acceleration of vibration at positions at which the acceleration sensors are attached to road bridge B2. Further, as state detection sensors 204a, 204b and 204c, for example, displacement sensors or inclination sensors may be used. The displacement sensors detect displacement amounts of road bridge B2 at the attached positions, for example, an interval between the bridge piers and a distance between the bridge beam and the bridge pier. Note that state detection sensors 204a, 204b and 204c are not limited to the above-described two types of sensors, and other types of sensors may be used.

<Controller 203>

Controller 203 controls operation of each component of state detection apparatus 201. Further, voltage sensor control circuit 290 is connected to controller 203, and voltage sensor 209 is connected to voltage sensor control circuit 290. Note that, while voltage sensor control circuit 290 is provided outside of controller 203 and is external connected to controller 203, voltage sensor control circuit 290 may be provided inside of controller 203.

<State Detection Sensor Control Circuits 240a, 240b and 240c>

State detection sensors 204a, 204b and 204c are respective connected to state detection sensor control circuits 240a, 240b and 240c. State detection sensor control circuits 240a, 240b and 240c include power supp circuits (not illustrated) which supp power to state detection sensors 204a, 204b and 204c to which state detection sensor control circuits 240a, 240b and 240c are connected, and processing circuits (not illustrated) which process detection signals of state detection sensors 204a, 204b and 204c to acquire state information. Because state detection sensors 204a, 204b and 204c are not limited to the above-described two types of sensors, and various types of sensors are used, state detection sensor control circuits 240a, 240b and 240c have circuit configurations in accordance with types of state detection sensors 204a, 204b and 204c to which state detection sensor control circuits 240a, 240b and 240c are connected. State detection sensor control circuits 240a, 240b and 240c receive detection signals of, for example, acceleration, displacement amounts and inclination angles in accordance with types of state detection sensors 204a, 204b and 204c to which state detection sensor control circuits 240a, 240b and 240c are connected.

An example will be described where state detection apparatus 201 of the present embodiment includes three state detection sensor control circuits 240a, 240b and 240c. However, state detection apparatus 201 may include, for example, one or two or four or more state detection sensor control circuits 240a, 240b and 240c. State detection apparatus 201 on has to include state detection sensor control circuits 240a, 240b and 240c corresponding to state detection sensors 204a, 204b and 204c for each of state detection sensors 204a, 204b and 204c to which state detection apparatus 201 is connected. Note that state detection sensor control circuits 240a, 240b and 240c do not have to be provided for each of state detection sensors 204a, 204b and 204c, and, for example, two or more state detection sensors may be connected to one state detection sensor control circuit 240a, 240b and 240c.

<Timer 205>

Timer 205 measures current date and time.

<Storage Unit 206>

Storage unit 206 stores various kinds of setting parameters to be used upon operation of state detection apparatus 201. The setting parameters include, for example, parameters regarding a timing for storing the state information which will be described later, a timing for transmitting the state information, a threshold voltage (this threshold voltage corresponds to the first threshold in Embodiment 1), and the threshold number of times. Further, storage unit 206 also has a storage region for temporarily storing data generated by operation of state detection apparatus 201. Storage unit 206 temporarily stores the state information acquired by processing the detection signals of state detection sensors 204a, 204b and 204c.

<Wireless Communicator 207>

Wireless communicator 207 controls wireless communication between state detection apparatus 201 and diagnosis apparatus 202.

<Power Supp 208>

Power supp 208 includes vibration power generating device 208a as a vibration power generator, and capacitor 208b. Vibration power generating device 208a and capacitor 208b are drive power supplies of state detection apparatus 201. Power supp 208 supplies power required for operation to each component of state detection apparatus 201 from capacitor 208b. As described above, state detection sensor control circuits 240a, 240b and 240c supp power to state detection sensors 204a, 204b and 204c to which state detection sensor control circuits 240a, 240b and 240c are connected. Further, capacitor 208b also supplies power to state detection sensors 204a, 204b and 204c.

<Vibration Power Generating Device 208a>

When vibration power generating device 208a is attached to, for example, road bridge B2, vibration power generating device 208a can generate power by vibration of road bridge B2 by a traveling vehicle. The power generated by vibration is supplied to capacitor 208b. Vibration power generating device 208a uses magnetostrictive vibration power generation. The magnetostrictive vibration power generation has characteristics of being advantageous in charging because its voltage is low and its resistance is low.

<Voltage Sensor Control Circuit 290>

Voltage sensor control circuit 290 is connected to controller 203 and voltage sensor 209. Voltage sensor control circuit 290 receives power supp from controller 203.

<Voltage Sensor 209>

Voltage sensor 209 is connected to vibration power generating device 208a. Voltage sensor 209 detects a voltage of a current generated by vibration power generating device 208a. For example, external force applied when a vehicle goes into and passes through road bridge B2 most affects damage of road bridge B2. Further, when large external force is applied, road bridge B2 further vibrates, and a power generation amount of vibration power generating device 208a increases. Voltage sensor 209 detects temporal change including fluctuation of the power generation amount from the change in voltage. The change in voltage detected by voltage sensor 209 has correlation with temporal change of the power generation amount of the current generated by vibration power generating device 208a. That is, there is correlation such that as the voltage becomes higher, the power generation amount increases over time. Therefore, controller 203 detects that the power generation amount generated by vibration power generating device 208a increases by increase in the voltage of power generation of vibration power generating device 208a. Voltage sensor 209 detects the voltage generated by vibration power generating device 208a at a time interval determined in advance (in the present embodiment, for example, once every 30 minutes).

Controller 203 supplies power to state detection sensor control circuits 240a, 240b and 240c and state detection sensors 204a, 204b and 204c from capacitor 208b on the basis of the change in voltage to drive state detection sensor control circuits 240a, 240b and 240c and state detection sensors 204a, 204b and 204c. State detection sensors 204a, 204b and 204c transmit detection signals of states to state detection sensor control circuits 240a, 240b and 240c. State detection sensor control circuits 240a, 240b and 240c process the detection signals of the states from state detection sensors 204a, 204b and 204c to acquire state detection information. Controller 203 receives the state information from state detection sensor control circuits 240a, 240b and 240c. In this manner, for example, it is possible to perform operation of acquiring the state of road bridge B2 while suppressing power required for the operation of acquiring the state. Further, for example, it is possible to perform operation of acquiring the state of road bridge B2 as appropriate. Still further, in the present embodiment, during operation of state detection apparatus 201, power is uninterrupted supplied to controller 203, timer 205 and storage unit 206 from capacitor 208b. However, power is not uninterrupted supplied to state detection sensor control circuits 240a, 240b and 240c and wireless communicator 207, and power is supplied from capacitor 208b as necessary. Specifically, power supp 208 turns on or off power supp from capacitor 208b to state detection sensor control circuits 240a, 240b and 240c and wireless communicator 207 in accordance with an instruction from controller 203.

<Diagnosis Apparatus 202>

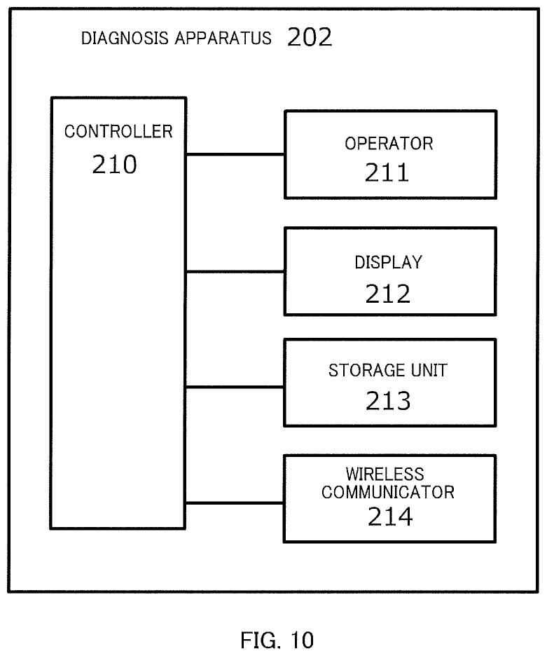

FIG. 10 is a block diagram illustrating a configuration of main components of diagnosis apparatus 202. Diagnosis apparatus 202 includes controller 210, operator 211, display 212, storage unit 213, and wireless communicator 214. Further, diagnosis apparatus 202 is connected to a commercial power supp. Diagnosis apparatus 202 may be a typical personal computer.

<Controller 210>

Controller 210 controls operation of each component of diagnosis apparatus 202, and diagnoses the state of road bridge B2 in accordance with parameters determined in advance on the basis of the state information from state detection sensor control circuits 240a, 240b and 240c. In a case where the state information is based on a detection signal of the acceleration sensor (detection signal of acceleration), controller 210 diagnoses the state of road bridge B2 in accordance with the parameter corresponding to the state information of the acceleration sensor. Further, in a case where the state information is based on a detection signal of the displacement sensor (detection signal of a displacement amount), controller 210 diagnoses the state of road bridge B2 in accordance with the parameter corresponding to the state information of the displacement sensor. Further, controller 210 diagnoses the state of road bridge B2 in accordance with the parameter corresponding to the state information of the inclination sensor. Still further, in a case where the state information is based on an amount of power generated by vibration power generating device 208a, controller 210 diagnoses the state of road bridge B2 in accordance with the parameter corresponding to the state info nation regarding the amount of power generated by vibration power generating device 208a.

<Operator 211>

While not illustrated, operator 211 includes an input device such as a keyboard and a mouse, and accepts input operation of an operator with respect to diagnosis apparatus 202.

<Display 212>

Display 212 includes, for example, a display (not illustrated), and displays a screen in accordance with input to diagnosis apparatus 202, or displays a screen in accordance with a processing result of processing executed at diagnosis apparatus 202, for example, processing of comparison with various kinds of parameters.

<Storage Unit 213>

Storage unit 213 stores parameters to be used during operation of diagnosis apparatus 202, and the state information of state detection sensor control circuits 240a, 240b and 240c transmitted from state detection apparatus 201.

<Wireless Communicator 214>

Wireless communicator 214 includes a wireless communication device, and controls wireless communication with state detection apparatus 201 attached to road bridge B2. Wireless communicator 214 receives the state information transmitted from state detection apparatus 201.

As described above, a state of an architecture such as, for example, road bridge B2 does not drastically change unless large external force (for example, external force by an earthquake) is applied. Therefore, state detection sensors 204a, 204b and 204c do not have to uninterrupted detect the state of road bridge B2, and can detect the state of road bridge B2 when needed by detecting the state of road bridge B2 when a voltage of power generated by vibration power generating device 208a becomes high (that is, when vibration of road bridge B2 increases). Further, it is possible to suppress power consumption required for detection of the state by state detection sensors 204a, 204b and 204c not uninterrupted detecting the state of road bridge B2. Further, there is a case where the state diagnosis apparatus of road bridge B in the present embodiment cannot obtain state information which is enough to determine any change in the state of road bridge B2 when, for example, there is a little traffic of vehicles on road bridge B2. Meanwhile, when, for example, there is a heavy traffic of vehicles on road bridge B2, because the state of road bridge B2 changes, architecture diagnosis apparatus 200 of the present embodiment is high like to be able to obtain the state information which is enough to determine any change in the state of road bridge B2. In this manner, architecture diagnosis apparatus 200 of the present embodiment can acquire the state information at an appropriate timing and can diagnose the state of road bridge B2 by driving state detection sensors 204a, 204b and 204c and transmitting the state information when there is a possibility that it is possible to determine any change in road bridge B2.

<Frequency of Instruction to Cause State Detection Apparatus 201 to Detect State of Road Bridge B2>

A timing at which state detection apparatus 201 detects the state of road bridge B2 will be described next.

Controller 203 instructs state detection sensors 204a, 204b and 204c to detect the state of road bridge B2, and state detection sensors 204a, 204b and 204c detect the state of road bridge B2 in accordance with the instruction and transmit detection signals to state detection sensor control circuits 240a, 240b and 240c. Controller 203 confirms whether there occurs a failure such as a breakage in state detection sensors 204a, 204b and 204c and state detection sensor control circuits 240a, 240b and 240c to which controller 203 is connected by acquiring the state information processed by state detection sensor control circuits 240a, 240b and 240c. A frequency of the instruction from controller 203 to state detection sensors 204a, 204b and 204c is determined by setting of a threshold voltage and a threshold number of times which will be described later. To suppress power consumption of state detection apparatus 201, it is preferable to set the frequency of the instruction as low as possible. Meanwhile, in order that diagnosis apparatus 202 may diagnose the state of the road, it is not appropriate if controller 203 does not acquire the state information for a long period of time. Therefore, the frequency of the instruction from controller 203 to state detection sensors 204a, 204b and 204c is set to, for example, equal to or less than three times a day. The frequency of the instruction from controller 203 to state detection sensors 204a, 204b and 204c may be set to equal to or less than four times a day. To appropriate diagnose the state of road bridge B2, it is preferable to set the frequency of the instruction from controller 203 to state detection sensors 204a, 204b and 204c at, for example, a frequency of equal to or more than once every three days, and the frequency may be set to once every two days.

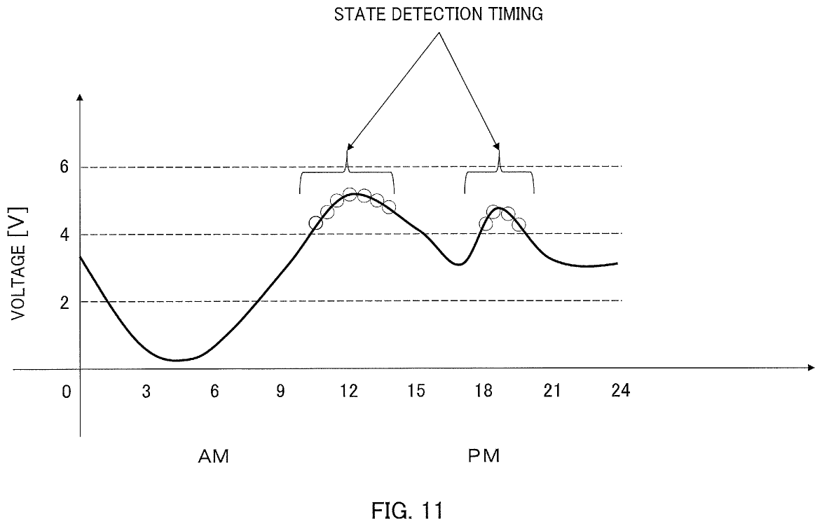

FIG. 11 is a graph illustrating a timing at which state detection apparatus 201 detects the state of road bridge B2. FIG. 11 indicates a voltage detected by voltage sensor 209 on a vertical axis and indicates time on a horizontal axis.

The threshold voltage and the threshold number of times of voltage sensor 209, which define driving of state detection sensors 204a, 204b and 204c will be described next. The threshold voltage of voltage sensor 209 is a parameter to be used by controller 203 to determine whether it is a timing for driving the state detection sensors. The threshold voltage correlates with the amount of power generated by vibration power generating device 208a. As the threshold voltage is set higher, the amount of power generated by vibration power generating device 208a increases in correlation to the threshold voltage. The threshold voltage is a voltage to be compared with a measurement value of the voltage stored in storage unit 206 of controller 203, and is set to, for example, 4V in advance.

The threshold number of times is a parameter of the number of times controller 203 determines that a voltage detected by voltage sensor 209 at a time interval of detection operation determined in advance, in the present embodiment, for example, once every 30 minutes, exceeds the threshold voltage. As described above, there is correlation such that, as the threshold number of times increases, the amount of power generated by vibration power generating device 208a increases. The threshold number of times is set to, for example, equal to or more than three times. In the present embodiment, the threshold voltage is set to 4V, and the threshold number of times is set to equal to or more than three times. Therefore, in the present embodiment, when the number of times the voltage exceeds the threshold voltage of 4V reaches three times, controller 203 drives state detection sensors 204a, 204b and 204c, and acquires the state information of road bridge B2 via state detection sensor control circuits 240a, 240b and 240c. As described above, when the measurement value of the voltage detected by voltage sensor 209 exceeds the set threshold voltage, state detection apparatus 201 counts the number of times, and when the voltage exceeds the threshold voltage the number of times equal to or more than the set threshold number of times, state detection apparatus 201 starts detection of the state. FIG. 11 illustrates a state where the measurement value of the voltage detected by voltage sensor 209, for example, once every 30 minutes exceeds the threshold voltage the number of times exceeding the threshold number of times (three times). Specifically, in FIG. 11, the number of times the voltage detected by voltage sensor 209 exceeds the threshold voltage for the first time is indicated with a portion displayed with a circle at the first peak portion. Further, the number of times the voltage detected by voltage sensor 209 exceeds the threshold next is displayed with a circle at the next peak portion. Because voltage sensor 209 detects a voltage once every 30 minutes, voltage sensor 209 detects that the voltage of the power generated by vibration power generating device 208a exceeds the threshold seven times in the first peak, and four times in the next peak. The threshold voltage of voltage sensor 209 at which state detection sensors 204a, 204b and 204c are driven is set to 4V. Therefore, in the present embodiment, in two peak portions illustrated in FIG. 11, controller 203 drives state detection sensors 204a, 204b and 204c and acquires the state information of road bridge B2 via state detection sensor control circuits 240a, 240b and 240c.

Note that an instruction to set the threshold voltage and the threshold number of times may be, for example, issued from diagnosis apparatus 202 via wireless communicator 207. Further, controller 203 may supp power to wireless communicator 207 when controller 203 accepts an instruction from diagnosis apparatus 202. According to this, it is possible to easily change the threshold voltage and the threshold number of times from diagnosis apparatus 202.

<Timing at which State Detection Apparatus 201 Transmits State Information to Diagnosis Apparatus 202>

A transmission timing at which state detection apparatus 201 transmits the state information to diagnosis apparatus 202 via wireless network WN2 will be described. As described above, in architecture diagnosis apparatus 200 in the present embodiment, a plurality of state detection apparatuses 201 which perform communication with diagnosis apparatus 202 in a wireless manner are attached to road bridge B2. Therefore, when the plurality of state detection apparatuses 201 try to perform communication with diagnosis apparatus 202 in a wireless manner at the same time using the same channel, there is a possibility that a communication error may occur due to collision of data signals of the state information. By setting a communication timing at which state detection apparatus 201 performs communication with diagnosis apparatus 202 in a wireless manner via wireless communication network WN2 for each state detection apparatus 201 so that time at which information is transmitted to diagnosis apparatus 202 does not over1ap with each other, it is possible to prevent the plurality of state detection apparatuses 201 from performing communication with diagnosis apparatus 202 in a wireless manner at the same time.

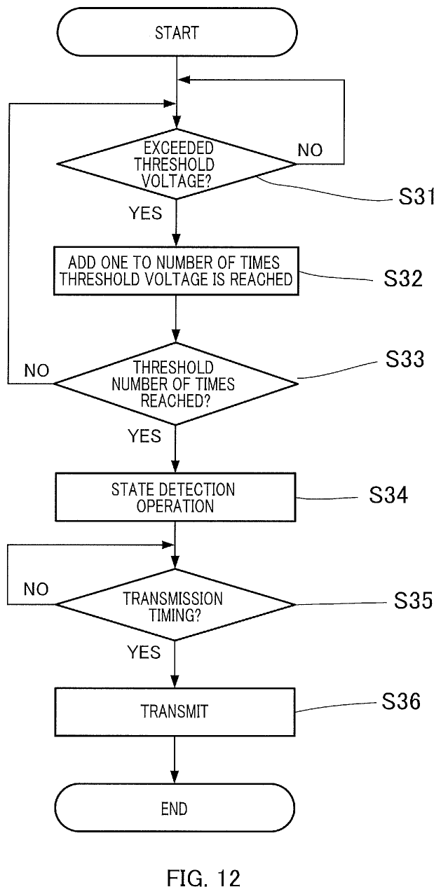

FIG. 12 is a flowchart illustrating an example of operation of state detection apparatus 201.

Firs, it is determined whether or not the voltage of power generation of vibration power generating device 208a exceeds the threshold voltage (step S31). This determination is performed by controller 203, and, when it is determined by controller 203 that the voltage of power generation of vibration power generating device 208a exceeds the threshold voltage (step S31: Yes), the processing proceeds to next step S32.

Then, controller 203 adds “1” to the number of times it is determined that the voltage exceeds the threshold voltage (step S32), and the processing proceeds to next step S33.

Next, it is determined whether or not the number of times it is determined that the voltage exceeds the threshold voltage is equal to or larger than the threshold number of times (step S33). This determination is performed by controller 203, and when it is determined that the number of times it is determined by controller 203 that the voltage exceeds the threshold voltage is equal to or larger than the threshold number of times (step S33: Yes), the processing proceeds to next step S34.

Then, operation of detecting the state information is performed (step S34). Controller 203 supplies power to voltage sensor control circuit 290 to drive voltage sensor control circuit 290, and causes power to be supplied from capacitor 208b to state detection sensors 204a, 204b and 204c to drive state detection sensors 204a, 204b and 204c. State detection sensors 204a, 204b and 204c detect the state and transmit detection signals of the state to state detection sensor control circuits 240a, 240b and 240c. State detection sensor control circuits 240a, 240b and 240c process the detection signals of the state and transmit the state information to controller 203. Controller 203 receives the state information from state detection sensor control circuits 240a, 240b and 240c and causes the state information to be stored in storage unit 206, and the processing proceeds to the next step (step S35).

Next, it is determined whether or not it is a timing for transmitting the state information (step S35). This determination is performed by controller 203, and controller 203 determines whether or not it is a transmission timing for transmitting the state information to diagnosis apparatus 202 on the basis of whether the timing corresponds to the transmission timing set for each state detection apparatus 201. When controller 203 determines that the timing corresponds to the transmission timing of the state information of the state detection apparatus 201 (step S35: Yes), the processing proceeds to next step (step S36).

Then, state detection apparatus 201 transmits the state information to diagnosis apparatus 202 (step S36), and this flow ends.

Note that when controller 203 determines in step S33 that the number of times it is determined that the voltage exceeds the threshold voltage is less than the threshold number of times, the processing returns to previous step S31.

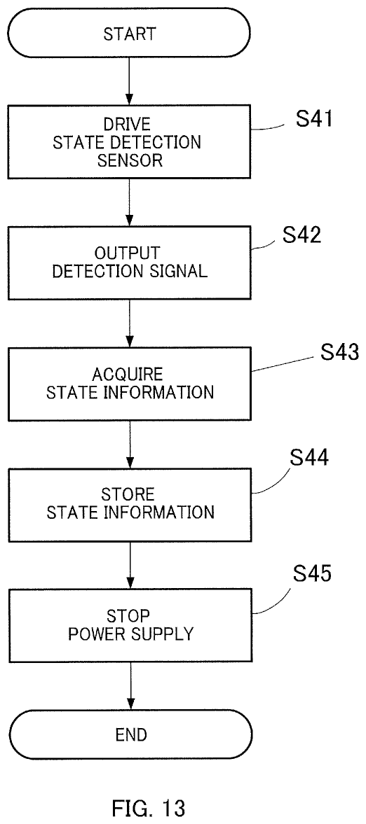

FIG. 13 is a flowchart illustrating an example of operation in which state detection apparatus 201 acquires the state information.

First, state detection apparatus 201 starts driving of state detection sensors 204a, 204b and 204c (step S41).

Then, power supp 208 starts power supp to state detection sensor control circuits 240a, 240b and 240c. When power is supplied, state detection sensors 204a, 204b and 204c detect the state information and output detection signals of the state to state detection sensor control circuits 240a, 240b and 240c (step S42). State detection sensor control circuits 240a, 240b and 240c process the detection signals of the state from state detection sensors 204a, 204b and 204c to acquire the state information.

Then, state detection apparatus 201 acquires the state information from state detection sensor control circuits 240a, 240b and 240c (step S43). The state information is state information based on the detection signals after a period determined in advance has elapsed (in the present embodiment, for example, after one second) since state detection sensors 204a, 204b and 204c had been driven (step S41). State detection apparatus 201 can acquire accurate state information by acquiring the state information based on detection information in a state where operation of state detection sensors 204a, 204b and 204c is stable.

Then, controller 203 stores the state information acquired in previous step S43 in storage unit 206 in association with acquisition date and time (step S44).

Then, controller 203 stops driving of state detection sensors 204a, 204b and 204c which has been started, stops power supp to state detection sensor control circuits 240a, 240b and 240c (step S45), and the flow ends.

In this manner, state detection apparatus 201 can suppress power consumption of state detection apparatus 201 by causing state detection sensors 204a, 204b and 204c to perform detection as appropriate instead of causing state detection sensors 204a, 204b and 204c to uninterrupted detect the state of road bridge B2. Further, because power supp from capacitor 208b to state detection sensor control circuits 240a, 240b and 240c is stopped while state detection sensors 204a, 204b and 204c are not driven, state detection apparatus 201 does not consume power wasteful. It is therefore possible to make life of capacitor 208b longer, and reduce a frequency of replacement of capacitor 208b.

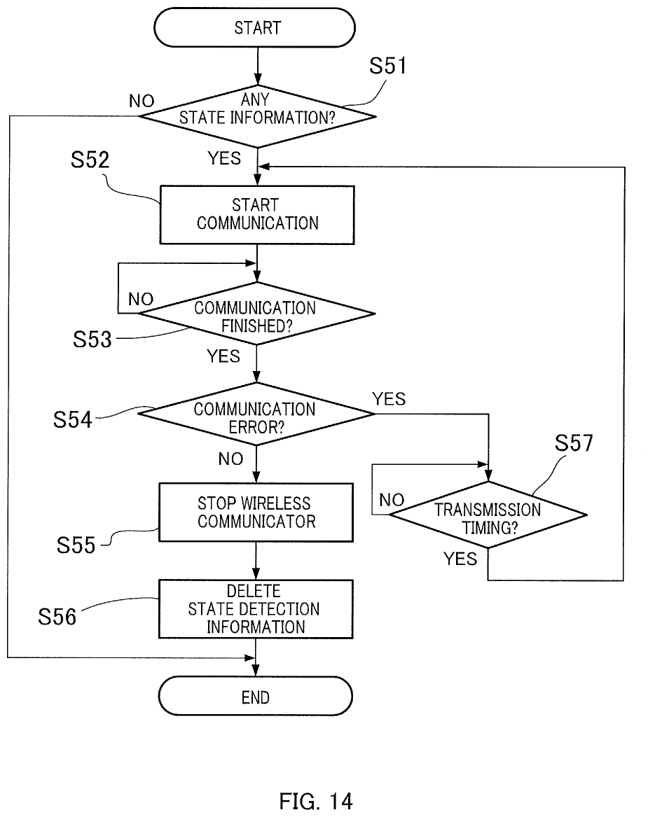

FIG. 14 is a flowchart illustrating an example of operation in which state detection apparatus 201 transmits the state information.

First, it is determined whether the state information is stored in storage unit 206 of controller 203 (step S51). This determination is performed by controller 203, and, in a case where it is determined that the state information is stored in storage unit 206 (step S51: Yes), the processing proceeds to next step S52. Note that, in a case where controller 203 determines that the state information is not stored in storage unit 206 (step S51: No), this flow ends.

Next, controller 203 starts power supp to wireless communicator 207 to drive wireless communicator 207. Controller 203 transmits the state information stored in storage unit 206 from state detection apparatus 201 to diagnosis apparatus 202 in a wireless manner using wireless communicator 207 via wireless network WN2 (step S52).

Next, it is determined whether or not communication is finished (step S53). This determination is performed by controller 203, and, in a case where controller 203 determines that the communication is finished (step S53: Yes), the processing proceeds to next step (step S54).

Then, it is determined whether or not the previous communication is finished by an error (step S54). This determination is performed by controller 203, and, in a case where controller 203 determines that there is no communication error (step S54: No), the processing proceeds to next step (step S55).

Then, controller 203 stops power supp to wireless communicator 207 (step S55).

Next, controller 203 deletes the communicated state detection information stored in storage unit 206, from storage unit 206 (step S56), and this flow ends.

Note that, in a case where controller 203 determines that state detection apparatus 201 cannot properly execute wireless communication and there is a communication error in previous step S54 (step S54: Yes), the processing proceeds to step S57.

Then, in step S57, it is determined whether or not it is the transmission timing described above (FIG. 12: step S35). In a case where controller 203 determines that it is the transmission timing, the processing returns to previous step S52.

In this manner, because state detection apparatus 201 drives wireless communicator 207 when the state information based on the detection signals detected at state detection sensors 204a, 204b and 204c is transmitted to diagnosis apparatus 202, it is possible to suppress power consumption of wireless communicator 207.

Further, while, in the present embodiment, an example where the state of road bridge B2 is diagnosed has been described, an architecture for which a state is to be diagnosed is not limited to this. Architecture diagnosis apparatus 200 may diagnose, for example, a railroad bridge on which a train travels, a tunnel through which a vehicle passes, a storage dam, or the like.

### MODIFIED EXAMPLES

In the above description, when the voltage of vibration power generating device 208a is high, controller 203 causes state detection sensors 204a, 204b and 204c to detect the state of road bridge B2. Therefore, controller 203 cannot uninterrupted detect the state of road bridge B2. However, vibration power generating device 208a generates power by vibration. Therefore, (1) in a case where the voltage of power generation of vibration power generating device 208a is higher than the threshold voltage, controller 203 causes state detection sensors 204a, 204b and 204c to detect road bridge B2. (2) In a case where the voltage of power generation of vibration power generating device 208a is lower than the threshold voltage, controller 203 detects a change in voltage by power generation of vibration power generating device 208a as the state (vibration) of road bridge B2. (3) In a case where the voltage of vibration power generating device 208a is equal to the threshold voltage, controller 203 detects a change in voltage of power generation of vibration power generating device 208a as the state (vibration) of road bridge B2 or causes state detection sensors 204a, 204b and 204c to detect road bridge B2. Therefore, controller 203 can uninterrupted detect the state of road bridge B2.

Further, controller 203 may refer to an amount of power generated by vibration power generating device 208a and a threshold of a power generation amount determined in advance as conditions for causing state detection sensors 204a, 204b and 204c or vibration power generating device 208a to operate. For example, (1) in a case where the amount of power generated by vibration power generating device 208a is higher than the threshold power generation amount, controller 203 causes state detection sensors 204a, 204b and 204c to detect road bridge B2. (2) In a case where the amount of power generated by vibration power generating device 208a is lower than the threshold power generation amount, controller 203 detects change in the amount of power generated by vibration power generating device 208a as the state (vibration) of road bridge B2. (3) In a case where the amount of power generated by vibration power generating device 208a is equal to the threshold power generation amount, controller 203 detects a change in the amount of power generated by vibration power generating device 208a as the state (vibration) of road bridge B2 or causes state detection sensors 204a, 204b and 204c to detect road bridge B2.

### Embodiment 3

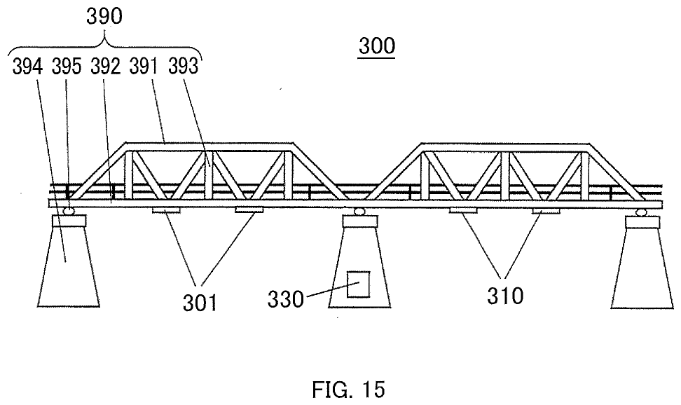

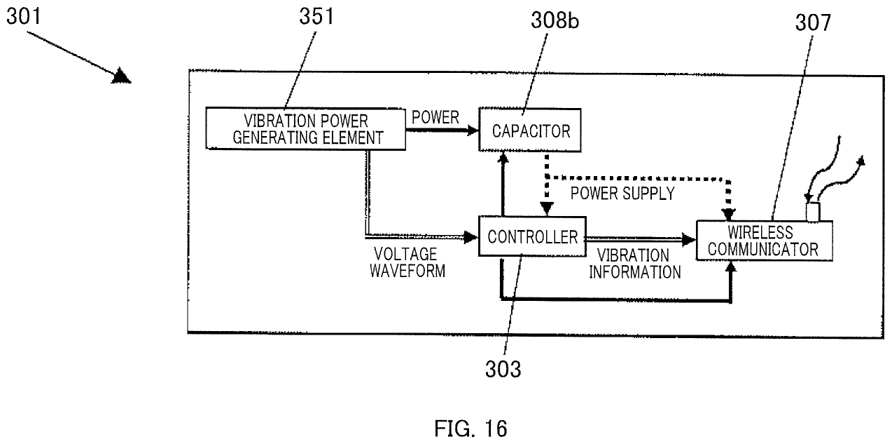

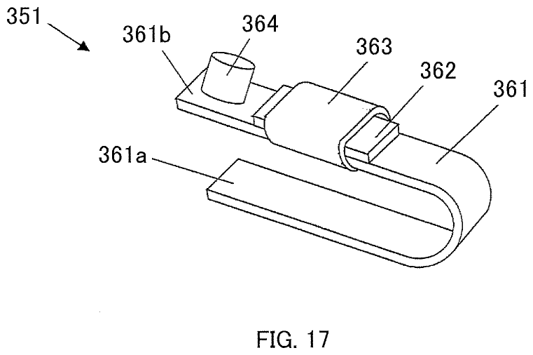

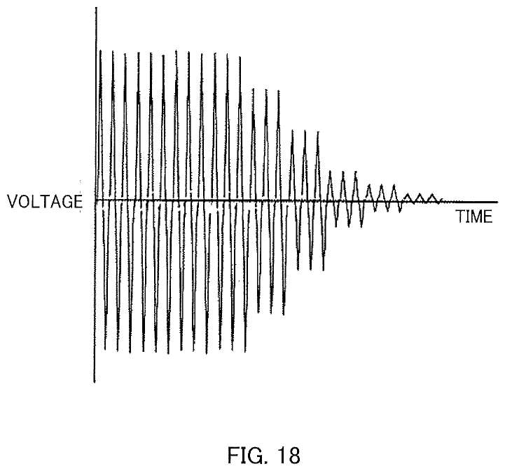

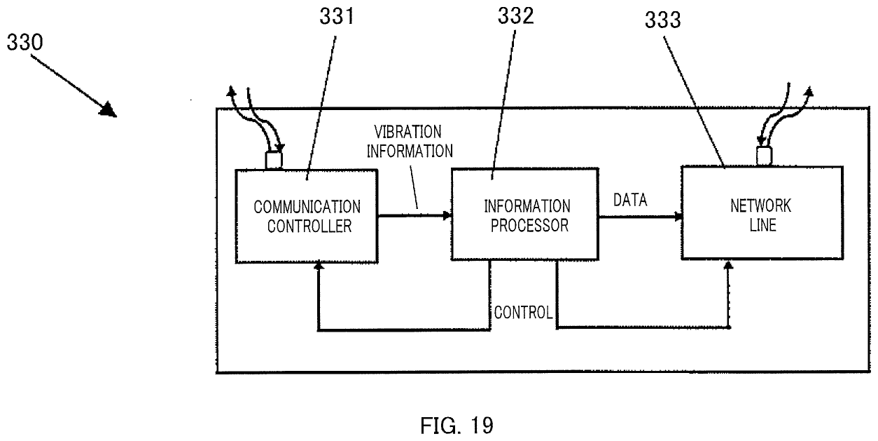

Architecture diagnosis apparatus 300 according to Embodiment 3 of the present disclosure will be described in detail with reference to the accompanying drawings. Architecture diagnosis apparatus 300 according to Embodiment 3 functions as a vibration amount monitoring analysis system. FIG. 15 illustrates a schematic configuration diagram in a case where architecture diagnosis apparatus 300 of the present disclosure is used for measuring vibration to estimate degradation of a railroad bridge. FIG. 16 illustrates a configuration diagram of state detection apparatus 301. State detection apparatus 301 functions as a vibration amount monitoring apparatus. FIG. 17 illustrates a perspective view of vibration power generating element 351 used in state detection apparatus 301. FIG. 18 schematically illustrates a voltage waveform of vibration power generating element 351 in a case where a train travels on a bridge. Further, FIG. 19 illustrates a configuration diagram of data collection apparatus 330.

Architecture diagnosis apparatus 300 of Embodiment 3 will be described in detail below using these accompanying drawings.

<Perspective>

Architecture diagnosis apparatus 300 of Embodiment 3 has a system configuration including state detection apparatus 301 which monitors vibration of bridge 390 which is an architecture, and data collection apparatus 330 which receives vibration information from state detection apparatus 301.

Further, state detection apparatus 301 is attached to a predetermined inspection position of bridge 390 which is an architecture, and includes vibration power generating element 351 which generates power by receiving vibration of bridge 390, capacitor 308b which accumulates power generated by vibration power generating element 351, controller 303 which acquires a voltage waveform of the power generated by vibration power generating element 351 and processes the voltage waveform as vibration information, and wireless communicator 307 which transmits the vibration information in a wireless manner. Note that, while not illustrated in FIG. 16, state detection apparatus 301 includes a power supp corresponding to power supplies 8 and 208 in Embodiments 1 and 2, and the power supp includes vibration power generating element 351 and capacitor 308b.

Further, controller 303 controls capacitor 308b and wireless communicator 307, and transmits the vibration information from wireless communicator 307 to data collection apparatus 330 with the power accumulated in capacitor 308b.

Data collection apparatus 330 includes communication controller 331 which performs communication with wireless communicator 307 of state detection apparatus 301, information processor 332 which processes the received vibration information, and network line 333 which transmits the data processed at information processor 332.

<Bridge 390>

As illustrated in FIG. 15, an architecture in Embodiment 3 is bridge 390, and this bridge 390 is a truss bridge. Bridge 390 has a structure which secures intensity by connecting upper chord member 391 and lower chord member 392 which is a main beam with truss 393, and shoe 395 is provided between bridge piers 394. Performance such as intensity of bridge 390 degrades in accordance with use for a long period of time. Therefore, it is necessary to accurate recognize change in performance of the bridge particularly after a certain period has elapsed. When the bridge degrades in accordance with an earthquake and traveling of trains, vibration of the bridge fluctuates.

State detection apparatus 301 is attached to main beam 392 in the present embodiment. While, in FIG. 15, a configuration is illustrated where state detection apparatus 301 is attached on a back side of main beam 392, state detection apparatus 301 may be attached on a side on which a train passes. As vibration power generating element 351 of this state detection apparatus 301, a magnetostrictive vibration power generating element is used.

<Vibration Power Generating Element 351>

FIG. 17 is a perspective view illustrating a specific configuration of a magnetostrictive vibration power generating element used as vibration power generating element 351. An alloy of iron and cobalt and an alloy of iron and gallium are known as a magnetostrictive material. When these alloys are elongated or contracted by force of compression or tension being applied, magnetization changes. When this change in magnetization is caused inside a coil around which a copper wire is wound, electricity is generated by a law of electromagnetic induction. The magnetostrictive vibration power generating element is based on this principle.

In FIG. 17, metal plate 361 having elasticity is bent in a U-shape, and magnetostrictive alloy 362 is fixed on one surface of metal plate 361. Coil 363 is wound so as to enclose magnetostrictive alloy 362. Further, weight 364 is attached to tip portion 361a of metal plate 361 on which magnetostrictive alloy 362 is fixed.

In Embodiment 3, other end portion 361b of metal plate 361 of vibration power generating element 351 is fixed at main beam 392 at which main beam 392 and truss 393 are pin-jointed. A position at which vibration power generating element 351 is fixed serves as an inspection position in Embodiment 3. Further, vibration power generating element 351 is provided so as to generate power by receiving vibration in a direction parallel to a traveling direction of a train at this inspection position. Note that it is preferable to receive vibration in a direction perpendicular to the traveling direction of the train.

As can be seen from FIG. 15, state detection apparatuses 301 in the present embodiment are respective provided at positions of main beams 392 at which main beams 392 of bridge 390 and trusses 393 are pin-jointed, and a total of four state detection apparatuses 301 are provided.

However, positions of state detection apparatuses 301 are not limited to the above-described positions, and state detection apparatuses 301 may be attached near bridge pier 394, truss 393 or shoe 395, or the like.

Metal plate 361 at which weight 364 is attached vibrates by receiving vibration of bridge 390, and magnetostrictive alloy 362 vibrates in a similar manner. By this means, force of compression and tension is alternate applied to magnetostrictive alloy 362, and a voltage is generated at coil 363. Controller 303 acquires a voltage waveform of the generated voltage, and capacitor 308b accumulates the generated power.

When a train travels on bridge 390, bridge 390 vibrates. Vibration power generating element 351 vibrates by this vibration in a similar manner, and generates a voltage. FIG. 18 is an example of a voltage waveform of the voltage generated in this manner. FIG. 18 illustrates an example of the voltage waveform in a case where an eight-car train travels on bridge 390 at 70 km per hour. A period during which the train passes is approximate 8 seconds, and during this period, a large amplitude continues, and when the train passes, an amplitude precipitous attenuates.

<Data Collection Apparatus 330>

Data collection apparatus 330 is provided on a surface of bridge pier 394 which is a central portion of four state detection apparatuses 301. Data collection apparatus 330 includes communication controller 331 which performs communication with wireless communicator 307 of state detection apparatus 301, information processor 332 which processes the received vibration information, and network line 333 which transmits the data processed at information processor 332.

Note that data collection apparatus 330 does not necessarily have to be provided at the central portion of four state detection apparatuses 301, and may be provided at bridge pier 394 of one of the both sides. Further, there is no particular restriction in a position on the surface of the bridge pier 394.

Further, in the present embodiment, architecture diagnosis apparatus 300 further includes diagnosis apparatus 340 including data receiver 341 which performs communication with network line 333 and acquires data, analyzer 342 which analyzes data, and display 343 which displays an analysis result. Diagnosis apparatus 340 functions as an analysis apparatus which analyzes data.

<Diagnosis Apparatus 340>

Because diagnosis apparatus 340 acquires data from data collection apparatus 330 via a wireless data line such as a mobile phone, a location where diagnosis apparatus 340 is provided is not limited to a location near the bridge pier, or the like, and may be provided at an office away from the bridge pier.

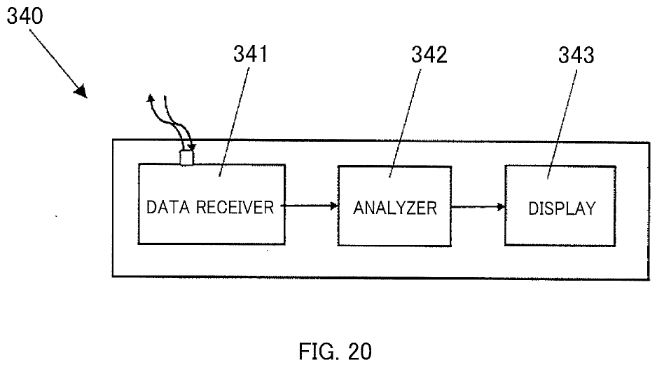

FIG. 20 illustrates a configuration of diagnosis apparatus 340. While diagnosis apparatus 340 includes data receiver 341, analyzer 342 which analyzes the acquired data, and display 343 which displays an analysis result, diagnosis apparatus 340 may be, for example, a personal computer.

<Degradation Evaluation Method using Architecture Diagnosis Apparatus 300>

A degradation evaluation method using architecture diagnosis apparatus 300 of the present embodiment will be described below.

In a case of railroad bridge 390, it is possible to recognize in advance, time, the number of cars of a train which passes through this bridge 390, and further whether trains in both directions pass through bridge 390 at the same time. Further, there is a case where bridge 390 vibrates by a typhoon or occurrence of an earthquake. Therefore, in a case where the bridge vibrates by sudden influence in addition to passing of a train, and vibration power generating element 351 of state detection apparatus 301 generates power, controller 303 acquires a voltage waveform of the power, and capacitor 308b accumulates the generated power at the same time. Controller 303 transmits vibration information which is compiled information of the voltage waveform and time information at which vibration occurs using the power of capacitor 308b from wireless communicator 307 to data collection apparatus 330.

Data collection apparatus 330 transmits the vibration information received from respective state detection apparatuses 301 from network line 333 as data to which apparatus information for each state detection apparatus 301 is added.

Diagnosis apparatus 340 receives this data at data receiver 341, and analyzes the data at analyzer 342. Diagnosis apparatus 340 may be a personal computer. Examples of analysis content can include, for example, an amplitude value, a vibration cycle, a vibration period, a vibration attenuation period, or the like. By recording these kinds of data on a daily basis, it is possible to determine to be normal when the data falls within a range of fixed values, and to send a maintenance worker to inspect the portion and perform maintenance work if otherwise a rise or fall or abnormal fluctuation of the data occurs for preventing progression of degradation.

By taking in all voltage waveforms of voltages generated as a result of vibration of bridge 390 in data collection apparatus 330 in this manner, it is possible to easily recognize abnormal vibration, or the like, due to an earthquake or a typhoon. Further, by adding data of architecture diagnosis apparatuses 300 provided at other bridges and performing analysis with artificial intelligence, it is possible to diagnose degradation in an extreme early stage.

While, in the present embodiment, state detection apparatus 301 transmits the voltage waveform of the generated voltage to data collection apparatus 330 every time a train passes, the present disclosure is not limited to this. For example, state detection apparatus 301 may transmit on a voltage waveform of vibration generated by a train which passes at specific time, to data collection apparatus 330.

Degradation of bridge 390 has characteristics of slow occurring by receiving load for a long period of time such as influence by traveling of trains, occurrence of corrosion, or the like, and further, influence of occurrence of natural disasters such as a typhoon and an earthquake. Therefore, degradation can be sufficient evaluated even if voltage waveforms generated by vibration of all trains are not collected. By avoiding collection of all voltage waveforms in this manner, it is possible to make capacity of capacitor 308b sufficient larger, and make transmission waves of state detection apparatus 301 larger.

Further, because vibration of bridge 390 by an earthquake and a typhoon is different from vibration by traveling of a train, a function may be added which, in a case where vibration different from typical vibration by traveling of a train occurs, adds a voltage waveform of the vibration as vibration information and transmits the vibration information to the data collection apparatus.

Further, while, in Embodiment 3, a case has been described where the state detection apparatus includes one vibration power generating element 351, the present disclosure is not limited to this. Vibration power generating elements 351 which generate power by receiving vibration in two directions which are orthogonal to each other may be provided in respective directions at state detection apparatus 301. Further, vibration power generating elements 351 which generate power by receiving vibration in three directions which are orthogonal to one another may be provided in respective directions. With such a configuration, because it is possible to obtain a voltage waveform by vibration in three directions including vibration in a direction (perpendicular in a vertical direction) orthogonal to a traveling direction and further, vibration in a perpendicular direction (perpendicular in a lateral direction) as well as vibration in the traveling direction of a train, it is possible to evaluate degradation more precise.

Note that, while, in the present embodiment, an amplitude value, an amplitude cycle, an amplitude period, an amplitude attenuation period, or the like, are obtained on the basis of the vibration information, and fluctuation, or the like, is analyzed at diagnosis apparatus 340, these may be obtained at data collection apparatus 330 and transmitted as the vibration information.

### Embodiment 4

Architecture diagnosis apparatus 400 according to Embodiment 4 of the present disclosure will be described in detail with reference to the accompanying drawings.

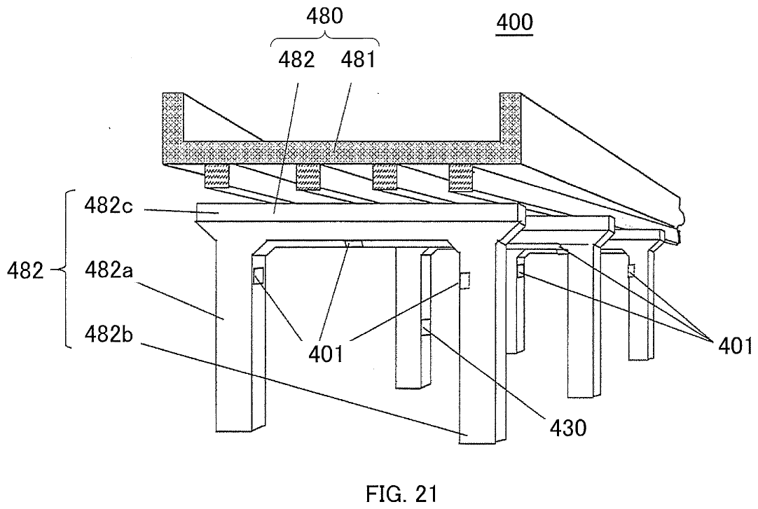

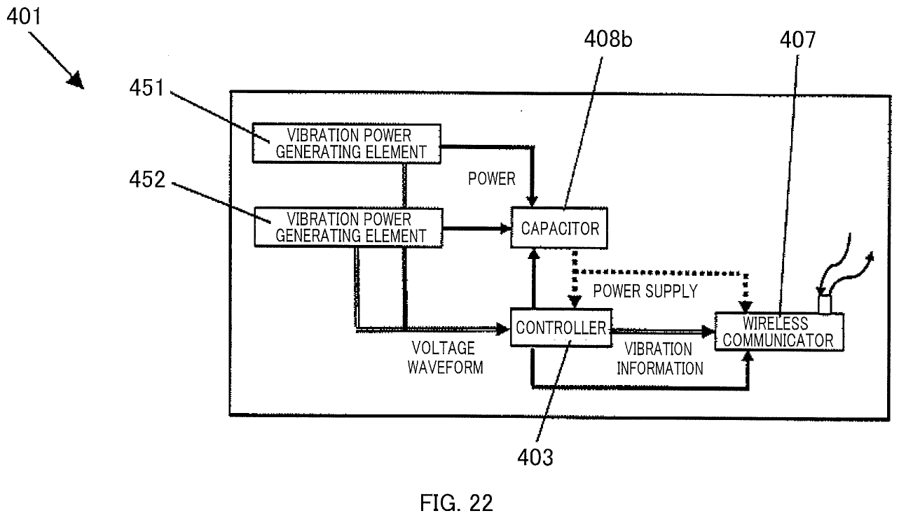

FIG. 21 illustrates a schematic configuration diagram in a case where architecture diagnosis apparatus 400 of the present disclosure is used for measuring vibration to estimate degradation of a lower structure of an expressway which is an architecture. Architecture diagnosis apparatus 400 according to Embodiment 4 functions as a vibration amount monitoring analysis system. FIG. 22 is a configuration diagram of state detection apparatus 401 according to the present embodiment. State detection apparatus 401 according to Embodiment 4 functions as a vibration amount monitoring apparatus.

As illustrated in FIG. 21, expressway 480 is made up of upper structure 481 in which an automobile travels, and lower structure 482 which supports this upper structure.

State detection apparatus 401 according to the present embodiment has two vibration power generating elements, which are respective provided at positions at which the vibration power generating elements receive vibration in two directions which are orthogonal at the inspection position. Capacitor 408b accumulates power generated by respective vibration power generating elements 451 and 452 receiving vibration of expressway 480, and controller 403 acquires voltage waveforms of respective vibration power generating elements 451 and 452 and transmits vibration information processed for each voltage waveform from wireless communicator 407 to data collection apparatus 430. Note that, while not illustrated in FIG. 22, state detection apparatus 401 includes a power supp corresponding to power supplies 8 and 208 in Embodiments 1 and 2 in a similar manner to Embodiment 3, and the power supp includes vibration power generating elements 451 and 452 and capacitor 408b.

In the present embodiment, state detection apparatuses 401 at which two vibration power generating elements 451 and 452 are provided are attached to columns 482a and 482b on both sides of lower structure 482 and at beam 482c which connects columns 482a and 482b.

Further, vibration power generating elements 451 and 452 of state detection apparatus 401 are provided so as to generate power by respective receiving vibration in a total of two directions including vibration in a direction parallel to a traveling direction of an automobile and vibration in a direction orthogonal to this direction.

Note that positions where state detection apparatuses 401 are provided are on upper portions of column 482a and 482b and a central portion of beam 482c. Because vibration power generating elements 451 and 452 which generate power by respective detecting vibration in two orthogonal directions are provided at state detection apparatus 401, it is possible to respective acquire vibration information in two directions generated in accordance with traveling of an automobile.

Also in Embodiment 4, magnetostrictive vibration power generating elements are used as vibration power generating elements 451 and 452 of state detection apparatus 401, and configurations of respective vibration power generating elements 451 and 452 are the same as the configuration illustrated in FIG. 17.

Further, also in Embodiment 4, data collection apparatus 430 is provided at one column of lower structure 482 to acquire the vibration information from state detection apparatus 401. In the present embodiment, three state detection apparatuses 401 are provided at every other lower structures 482, and data collection apparatus 430 is provided at an intermediate lower structure. However, positions where state detection apparatuses 401 and data collection apparatus 430 are provided are not limited to a case in the present embodiment. State detection apparatus 401 can be provided at any position where vibration of the lower structure is like to occur without particular limitations. Further, a position where data collection apparatus 430 is provided is not particularly limited if the position is a position where data collection apparatus 430 can perform communication with state detection apparatus 401.

Further, while a diagnosis apparatus is used also in Embodiment 4, because configurations of the data collection apparatus and the diagnosis apparatus are the same as those in Embodiment 3, description of specific configurations will be omitted.

A degradation evaluation method using architecture diagnosis apparatus 400 of the present embodiment will be described below.

In an expressway, not on cars having various sizes and weights such as a light vehicle, an ordinary vehicle and a truck travel, but cars travel at various time. Therefore, controller 403 acquires voltage waveforms of power generated by vibration power generating elements 451 and 452 every time various vehicles pass. At this time, controller 403 recognizes a vibration power generating element out of vibration power generating elements 451 and 452, which generates the voltage waveform, and sets the vibration power generating element as element information, and adds time information to the element information to make vibration information. This vibration information is transmitted from wireless communicator 407.

Data collection apparatus 430 transmits the vibration information received from a plurality of state detection apparatuses 401 (six in FIG. 21) as data to which apparatus information is added for each state detection apparatus, from network line 333.

Diagnosis apparatus 340 receives this data and analyzes this data at analyzer 342. Diagnosis apparatus 340 may be a personal computer. As analysis content, an amplitude value, an amplitude cycle, an amplitude period, an amplitude attenuation period, or the like, are obtained from the vibration information of the respective vibration power generating elements on the basis of the element information, the time information and the apparatus information from the acquired data. These kinds of data are recorded on a daily basis, and average values and variation of amplitude values, amplitude cycles, amplitude periods and amplitude attenuation periods are obtained. By obtaining transition of these kinds of data on a week basis, on a month basis or on a yearly basis, it is possible to determine a level of degradation.

For example, when these kinds of data fall within ranges of fixed values, it is determined to be normal. However, because voltage waveforms by vibration in two directions which are orthogonal to each other are acquired although at the same inspection position, there may be a case where while one of the voltage waveforms falls within a normal range, the other deviates from the normal range. In this case, it can be determined that some abnormality occurs. According to such an evaluation method, it is possible to determine whether or not there is an abnormality in an initial stage in which it is impossible to perform determination on with vibration information in one direction. By this means, because it is possible to specifically specify a portion to be inspected and a maintenance worker can perform inspection early, it is possible to prevent progression of degradation in an early stage.

While, in the present embodiment, state detection apparatus 401 transmits the voltage waveform to data collection apparatus 430 as the vibration information every time power is generated by vibration being received, the present disclosure is not limited to this. For example, it is also possible to add element information and time information to the voltage waveform generated in a certain time slot to make vibration information and transmit this vibration information to data collection apparatus 430. Data collection apparatus 430 may add apparatus information for determining state detection apparatus 401 which transmits the vibration information, to the vibration information acquired from a plurality of state detection apparatuses 401, and may transmit the vibration information from network line 333.

Diagnosis apparatus 340 performs analysis at analyzer 342 on the basis of the received data. Note that diagnosis apparatus 340 may be a personal computer. As analysis content, an amplitude value, an amplitude cycle, an amplitude period, an amplitude attenuation period, or the like, are obtained from the vibration information of the respective vibration power generating elements on the basis of the element information, the time information and the apparatus information from the acquired data. These kinds of data are recorded on a daily basis, and average values and variation of the amplitude values, the amplitude cycles, the amplitude periods and the amplitude attenuation periods are obtained. It is possible to determine a level of degradation by obtaining transition of these kinds of data on a week basis, on a month basis or on a yearly basis.

While on the voltage waveform generated in a certain time slot in one day is taken in as data in this evaluation method, because a level of degradation is evaluated by determining any change in data for a long period of time, it is possible to perform evaluation sufficient also using such a method. Meanwhile, because vibration power generating elements generate power also in other time slots and the power is accumulated in the capacitor, the controller and the communicator can use relative large power, so that it is possible to secure a sufficient communication distance.

Note that, while a case has been described in the present embodiment where the state detection apparatus in which vibration power generating elements 451 and 452 which generate power by vibration in two directions which are orthogonal to each other are respective provided, the present disclosure is not limited to this. It is also possible to use a state detection apparatus which includes one vibration power generating element as described in Embodiment 3.

Note that, while, in the present embodiment, an amplitude value, an amplitude cycle, an amplitude period, an amplitude attenuation period, or the like, are obtained on the basis of the vibration information, and fluctuation, or the like, are analyzed at diagnosis apparatus 340, these kinds of data may be obtained at data collection apparatus 430 and transmitted as the vibration information.

### Embodiment 5

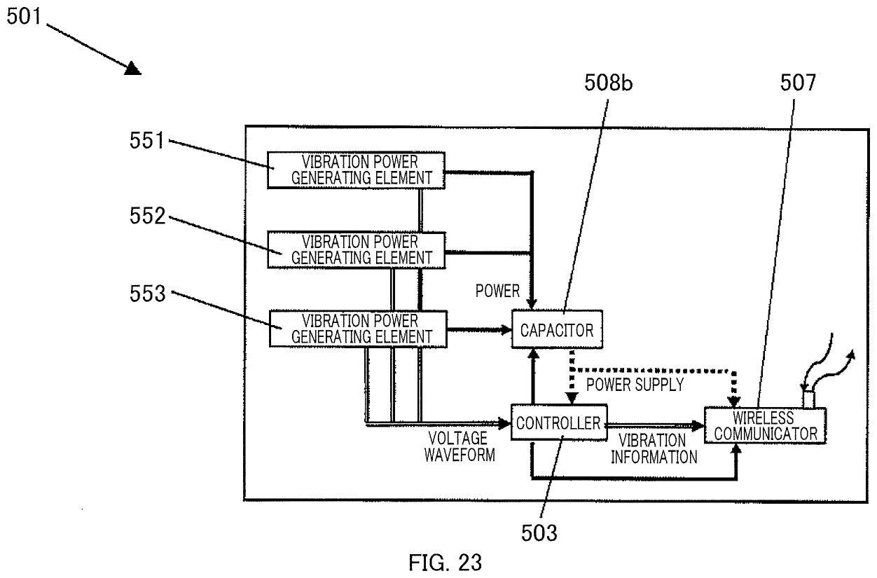

Architecture diagnosis apparatus 500 according to Embodiment 5 of the present disclosure will be described with reference to the accompanying drawings. FIG. 23 illustrates a configuration of state detection apparatus 501 to be used in architecture diagnosis apparatus 500 according to Embodiment 5. Architecture diagnosis apparatus 500 according to Embodiment 5 functions as a vibration amount monitoring analysis system, and state detection apparatus 501 functions as a vibration amount monitoring apparatus.

State detection apparatuses 501 are respective provided at positions where vibration power generating elements 551, 552 and 553 receive vibration in three directions which are orthogonal to one another at inspection positions. Capacitor 508b accumulates power generated by respective vibration power generating elements 551, 552 and 553 receiving vibration of an architecture, and controller 503 acquires voltage waveforms of the respective vibration power generating elements 551, 552 and 553, and transmits the vibration information processed for each of the respective waveforms from wireless communicator 507 to data collection apparatus 530. Note that, while not illustrated in FIG. 23, state detection apparatus 501 includes a power supp corresponding to power supplies 8 and 208 in Embodiments 1 and 2 in a similar manner to Embodiments 3 and 5, and the power supp includes vibration power generating elements 551, 552 and 553 and capacitor 508b.

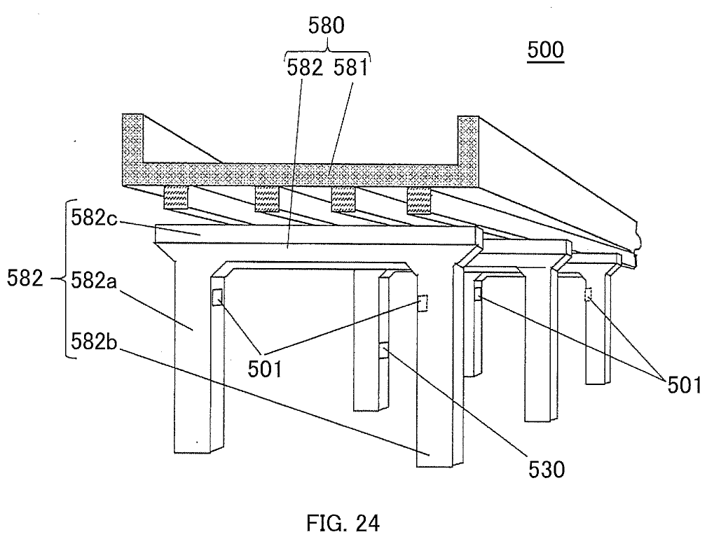

A case will be described where architecture diagnosis apparatus 500 according to the present embodiment is used for measuring vibration to estimate degradation of a lower structure of an expressway in a similar manner to Embodiment 4. FIG. 24 illustrates a configuration where state detection apparatus 501 is provided on expressway 580. Because expressway 580 is the same as that in Embodiment 4, description will be omitted.

In the present embodiment, state detection apparatuses 501, each of which includes three vibration power generating elements, are respective provided at positions where state detection apparatuses 501 receive vibration in three directions which are orthogonal to one another at inspection positions. Capacitor 508b accumulates power generated by the respective vibration power generating elements 551, 552 and 553 receiving vibration of expressway 580, and controller 503 acquires voltage waveforms of the respective vibration power generating elements 551, 552 and 553 and transmits the vibration information to which element information is added for each voltage waveform, from wireless communicator 507 to data collection apparatus 530. Note that, because data collection apparatus 530 is the same as the data collection apparatuses described in Embodiments 3 and 4, description will be omitted.

In the present embodiment, state detection apparatuses 501 in which three vibration power generating elements are provided are attached to columns 582a and 582b on both sides of lower structure 582. Then, vibration power generating elements 551, 552 and 553 of state detection apparatus 501 are provided so as to generate power by respective receiving vibration in a total of three directions including a direction parallel to a traveling direction of an automobile and two directions orthogonal to this direction. Note that positions where state detection apparatuses 501 are provided are positions of upper portions of columns 582a and 582b. Because vibration power generating elements 551, 552 and 553 which generate power by respective receiving vibration in three directions which are orthogonal to one another are provided at state detection apparatus 501, state detection apparatus 501 can respective acquire vibration information in three directions which is generated in accordance with traveling of an automobile.

Also in the present embodiment, magnetostrictive vibration power generating elements are used as vibration power generating elements 551, 552 and 553 of state detection apparatus 501, and configurations of respective vibration power generating elements 551, 552 and 553 are the same as those illustrated in FIG. 17.

Further, also in the present embodiment, data collection apparatus 530 is provided at one of columns of lower structure 582 to acquire the vibration information from state detection apparatus 501. In the present embodiment, three state detection apparatuses 501 are provided at every other lower structures 582, and data collection apparatus 530 is provided at an intermediate lower structure. Further, while a diagnosis apparatus is used also in Embodiment 5, because configurations of the data collection apparatus and the diagnosis apparatus are the same as those in Embodiment 3, description of specific configurations will be omitted.

<Degradation Evaluation Method using Architecture Diagnosis Apparatus 500>

A degradation evaluation method using architecture diagnosis apparatus 500 of the present embodiment will be described below.

In an expressway, as described in Embodiment 4, not on cars having various sizes and weights travel, but cars travel at various time. Therefore, the time slot is limited to a time slot in which a ratio of large trucks is greater than a ratio of passenger cars, for example, a specific time slot at night. In this time slot, controller 503 acquires voltage waveforms of power generated by vibration power generating elements 551, 552 and 553 by vibration occurring when vehicles travel being received. At this time, controller 503 recognizes a power generating element which generates the voltage waveform, among vibration power generating elements 551, 552 and 553, and adds element information. At the same time, time information and the element information for distinguishing a vibration power generating element which generates the vibration information are added to make the vibration information. Meanwhile, the power generated by vibration power generating elements 551, 552 and 553 by vibration of various vehicles which pass through expressway 580 being received is accumulated in capacitor 508b. Controller 503 transmits the above-described vibration information to data collection apparatus 530 using the power accumulated in capacitor 508b.

Data collection apparatus 530 transmits the vibration information received from a plurality of state detection apparatuses 501 (four in FIG. 24) as data to which apparatus information is added for each state detection apparatus, from network line 333.

Diagnosis apparatus 340 receives this data and analyzes this data at analyzer 342. Diagnosis apparatus 340 may be a personal computer. As analysis content, an amplitude value, an amplitude cycle, an amplitude period, an amplitude attenuation period, or the like, are obtained from the vibration information of the respective vibration power generating elements on the basis of the element information, the time information and the apparatus information from the acquired data. These kinds of data are recorded on a daily basis, and average values and variation of the amplitude values, the amplitude cycles, the amplitude periods and the amplitude attenuation periods are obtained. It is possible to determine a level of degradation by obtaining transition of these kinds of data on a week basis, on a month basis or on a yearly basis.

For example, when these kinds of data fall within ranges of fixed values, it is determined to be normal. In this case, because voltage waveforms by vibration in three directions which are orthogonal to one another are obtained even at the same inspection position, it is possible to predict that some abnormality occurs even if data from one vibration power generating element falls within a normal range, when data from both or one of the other two vibration power generating elements deviates from the normal ranges. By analyzing whether respective pieces of data in three directions fall within normal ranges or deviate from the normal ranges for a plurality of provided state detection apparatuses 501, it is possible to determine whether or not there is an abnormality in an initial stage in which it is impossible to perform determination on with vibration information in one direction. By this means, because it is possible to specifically specify a position to be inspected, and a maintenance worker can perform inspection early, it is possible to prevent progression of degradation in an early stage.

While, in the present embodiment, state detection apparatus 501 uses a voltage waveform of power generated by vibration by vehicles traveling in a specific time slot at night in one day being received, as the vibration information, and accumulates power generated in other time slots in capacitor 508b, the present disclosure is not limited to this. For example, it is also possible to transmit the voltage waveform generated by vibration of an automobile which passes to data collection apparatus 530 as the vibration information to which element information and time information are added. Then, data collection apparatus 530 may transmit data obtained by adding apparatus information which indicates state detection apparatus 501 which transmits the vibration information to the vibration information acquired from a plurality of state detection apparatuses 501, from network line 333.

Diagnosis apparatus 340 divides the received data for each of the respective state detection apparatuses 501 and analyzes the data at analyzer 342. Note that diagnosis apparatus 340 may be a personal computer. As analysis content, an amplitude value, an amplitude cycle, an amplitude period, an amplitude attenuation period, or the like, are obtained from the vibration information of the respective vibration power generating elements on the basis of the element information, the time information and the apparatus information from the acquired data. These kinds of data are recorded on a daily basis, and average values and variation of the amplitude values, the amplitude cycles, the amplitude periods, and the amplitude attenuation periods are obtained. It is possible to determine a level of degradation by obtaining transition of these kinds of data on a week basis, on a month basis or on a yearly basis.

For example, because vibration information in three directions whose vibration directions are different although at the same inspection position are acquired, it can be understood that when it is determined that one of the vibration information deviates from a fixed range, an abnormality occurs. By comparing and evaluating whether the vibration information is normal or abnormal for three directions of a plurality of state detection apparatuses 501, it is possible to determine an abnormality which cannot be determined on with vibration information in one direction. Therefore, it is possible to specify a location where a maintenance worker is to perform inspection more specifically, so that it is possible to prevent progression of degradation.

Note that, while, in the present embodiment, an amplitude value, an amplitude cycle, an amplitude period, an amplitude attenuation period, or the like, are obtained on the basis of the vibration information, and fluctuation, or the like, are analyzed at diagnosis apparatus 340, these may be obtained at data collection apparatus 530 and transmitted as the vibration information.

<Conclusion of Embodiments 3 to 5>

To solve the above-described conventional problems, an architecture diagnosis apparatus is used which includes a state detection apparatus which monitors vibration of an architecture, and a data collection apparatus which receives vibration information from the state detection apparatus, the state detection apparatus including a vibration power generating element which is attached to a predetermined inspection position of the architecture and which generates power by receiving vibration of the architecture, a capacitor which accumulates power generated by the vibration power generating element, a controller which acquires a voltage waveform of the power generated by the vibration power generating element and processes the voltage waveform as vibration information, and a wireless communicator which transmits the vibration information in a wireless manner, the controller controlling the capacitor and the wireless communicator, and transmitting the vibration information from the wireless communicator to the data collection apparatus with power accumulated in the capacitor, and the data collection apparatus including a communication controller which performs communication with the wireless communicator of the state detection apparatus, an information processor which processes the received vibration information, and a network line which transmits the data processed at the information processor.

With such a configuration, the state detection apparatus processes vibration information on the basis of a voltage waveform generated on the basis of vibration for an architecture such as a bridge and a viaduct of an expressway at which vibration occurs, and the data collection apparatus transmits data which is obtained by acquiring and processing the vibration information. By accumulating data processed on the basis of the vibration information for a long period of time, it is possible to recognize a degree of progression of degradation of the architecture. By this means, it is possible to perform appropriate repair before degradation becomes apparent or in an initial stage of degradation.

Further, by comparing the vibration information generated by influence of an earthquake, a typhoon, or the like, with the vibration information until then and the vibration information thereafter, it is also possible to evaluate influence of the earthquake, the typhoon, or the like, on degradation of an architecture.

Still further, because the data processed on the basis of the vibration information at the data collection apparatus is transmitted from the network line, a position where the data collection apparatus is provided can be free selected.

In the above-described configuration, it is also possible to employ a system configuration where the data collection apparatus performs communication with wireless communicators of a plurality of state detection apparatuses, receives the vibration information from the respective state detection apparatuses and processes the vibration information.

With such a configuration, for example, by providing one data collection apparatus which acquires and processes the vibration information for four state detection apparatuses, it is possible to simplify an overall system configuration and reduce load of installation work.

Still further, in the above-described configuration, it is also possible to employ a configuration further including a diagnosis apparatus which includes a data receiver which performs communication with the network line and acquires data, an analyzer which analyzes data, and a display which displays an analysis result.

With such a configuration, because data based on the vibration information collected and processed at the data collection apparatus is taken into the diagnosis apparatus through the network line, it is possible to easily analyze change in the vibration information over time for a long period of time, so that it is possible to improve accuracy of degradation prediction. Note that it is preferable to use a wireless communication line to be used for a mobile phone as the network line.

Further, in the above-described configuration, it is also possible to employ a system configuration where the vibration power generating elements are respective provided at positions where the vibration power generating elements receive vibration in two directions which are orthogonal at inspection positions of the architecture, the capacitor accumulates power generated by the respective vibration power generating elements receiving vibration of the architecture, and the controller acquires voltage waveforms of the respective vibration power generating elements and transmits vibration information processed for each of the respective voltage waveforms from the wireless communicator to the data collection apparatus.

With such a configuration, because vibration information is obtained by acquiring vibration in two directions occurring in accordance with traveling of a train and an automobile as voltage waveforms for a bridge and a viaduct, it is possible to evaluate a level of degradation of the architecture in more detail. Further, because the capacitor is charged with power generated by two vibration power generating elements, it is possible to increase capacity as well as shorten a charging period.

Further, in the above-described configuration, it is also possible to employ a system configuration where the vibration power generating elements are respective provided at positions where the vibration power generating elements receive vibration in three directions which are orthogonal to one another at the inspection positions, the capacitor accumulates power generated by the respective vibration power generating elements receiving vibration of the architecture, and the controller acquires voltage waveforms of the respective vibration power generating elements and transmits vibration information processed for each of the respective voltage waveforms from the wireless communicator to the data collection apparatus.

With such a configuration, because vibration information is obtained by acquiring vibration in three directions occurring in accordance with traveling of a train and an automobile as voltage waveforms for a bridge and a viaduct, it is possible to evaluate a level of degradation of the architecture further ear1ier and precise. Further, because the capacitor is charged with power generated by three vibration power generating elements, it is possible to increase capacity as well as shorten a charging period.

Further, in the above-described configuration, it is also possible to employ a system configuration where the vibration power generating element is formed with a magnetostrictive vibration power generating element. By using the magnetostrictive vibrator, because it is possible to obtain a large amount of power generation as well as increase durability of the vibration power generating element, it is possible to increase processing performance at the controller and make a communication distance longer.

In the architecture diagnosis apparatus according to Embodiments 3 to 5, the vibration power generating elements detect vibration occurring at the architecture by a train, an automobile, or the like, traveling, and generate power. Because this power is not on accumulated in the capacitor, but also used for monitoring a long-term degradation state of the architecture by obtaining vibration information from voltage waveforms, a large effect of being able to reduce load of a maintenance worker is provided.

### INDUSTRIAL APPLICABILITY

The state detection apparatus, the state detection method and the architecture diagnosis apparatus of the present disclosure are useful in a technology for diagnosing a state of an architecture.

### REFERENCE SIGNS LIST

1 State detection apparatus
2 Diagnosis apparatus
3 Controller
4 State detection sensor group
4a State detection sensor
4b State detection sensor
4c State detection sensor
5 Timer
6 Storage unit
7 Wireless communicator
8 Power supp
8a Vibration power generating device
8b Capacitor
9 Voltage sensor
10 Controller
11 Operator
12 Display
13 Storage unit
14 Wireless communicator
100 Architecture diagnosis apparatus
WN1 Wireless network
200 Architecture diagnosis apparatus
201 State detection apparatus
202 Diagnosis apparatus
203 Controller
204a State detection sensor
204b State detection sensor
204c State detection sensor
205 Timer
206 Storage unit
207 Wireless communicator
208 Power supp
208a Vibration power generating device
208b Capacitor
209 Voltage sensor
210 Controller
211 Operator
212 Display
213 Storage unit
214 Wireless communicator
240a State detection sensor control circuit
240b State detection sensor control circuit
240c State detection sensor control circuit
290 Voltage sensor control circuit
WN2 Wireless network
300 Architecture diagnosis apparatus
301 State detection apparatus
303 Controller
307 Wireless communicator
308b Capacitor
330 Data collection apparatus
331 Communication controller
332 Information processor
333 Network line
340 Diagnosis apparatus
341 Data receiver
342 Analyzer
343 Display
351 Vibration power generating element
361 Metal plate
361a tip portion
361b end portion
362 Magnetostrictive alloy
363 Coil
364 Weight
390 Bridge
391 Upper chord member
392 Lower chord member (main beam)
393 Truss
394 Bridge pier
395 Shoe
400 Architecture diagnosis apparatus
401 State detection apparatus
403 Controller
407 Wireless communicator
408b Capacitor
430 Data collection apparatus
451 Vibration power generating element
452 Vibration power generating element
480 Expressway
481 Upper structure
482 Lower structure
482a Column
482b Column
482c Beam
500 Architecture diagnosis apparatus
501 State detection apparatus
503 Controller
507 Wireless communicator
508b Capacitor
530 Data collection apparatus
551 Vibration power generating element
552 Vibration power generating element
553 Vibration power generating element
580 Expressway
582 Lower structure
582a Column
582b Column

1. A state detection apparatus, comprising:
a state detection sensor that is attached to an architecture and that detects a state of the architecture;
a power supp that generates power on a basis of vibration of the architecture; and
a controller that controls the state detection sensor and the power supp, wherein
the controller supplies power to the state detection sensor to drive the state detection sensor in a case where a voltage by the power generation exceeds a first threshold, and
the controller acquires state information to be used for diagnosing the state of the architecture on a basis of a signal indicating a detection result received from the state detection sensor.

2. The state detection apparatus according to claim 1, further comprising:
a wireless communicator that wireless communicates with a diagnosis apparatus that diagnoses the state of the architecture on a basis of the state information, wherein
the controller supplies power to the wireless communicator to cause the wireless communicator to transmit the state information to the diagnosis apparatus at a timing determined in advance.

3. The state detection apparatus according to claim 1, wherein
the controller supplies power to the state detection sensor to drive the state detection sensor during a specified period from a timing at which the voltage by the power generation exceeds the first threshold, and
the controller stops supping the power to the state detection sensor after the specified period has elapsed.

4. The state detection apparatus according to claim 3, wherein
the controller reduces an amount of power supp to the state detection sensor in a case where the voltage by the power generation is equal to or less than a second threshold during the specified period.

5. The state detection apparatus according to claim 3, wherein
the controller does not acquire the state information from a signal detected by the state detection sensor when the voltage by the power generation is equal to or less than a second threshold during the specified period.

6. The state detection apparatus according to claim 2, wherein
the controller stops supping the power to the wireless communicator and deletes the state information held at the state detection apparatus, in a case where there is no communication error in transmission of the state information, and
the controller causes the wireless communicator to execute transmission of the state information at a next timing of the timing determined in advance, in a case where there is a communication error in transmission of the state information.

7. The state detection apparatus according to claim 1, further comprising:
a voltage sensor that detects the voltage by the power generation, wherein
the controller determines whether or not the voltage detected by the voltage sensor exceeds the first threshold.

8. A state detection method to be performed by an apparatus comprising a state detection sensor that is attached to an architecture and that detects a state of the architecture, and a power supp that generates power on a basis of vibration of the architecture, the state detection method comprising:
supping power to the state detection sensor to drive the state detection sensor, in a case where a voltage by the power generation exceeds a first threshold; and
acquiring state information to be used for diagnosing the state of the architecture on a basis of a signal indicating a detection result received from the state detection sensor.

9. An architecture diagnosis apparatus, comprising:
a state detection apparatus and a diagnosis apparatus, wherein
the state detection apparatus, comprises:
a state detection sensor that is attached to an architecture and that detects a state of the architecture;
a power supp that generates power on a basis of vibration of the architecture; and
a controller that controls the state detection sensor and the power supp, wherein
the controller supplies power to the state detection sensor to drive the state detection sensor in a case where a voltage by the power generation exceeds a first threshold and acquires state information to be used for diagnosing the state of the architecture on a basis of a signal indicating a detection result received from the state detection sensor, and wherein
the diagnosis apparatus diagnoses the state of the architecture on a basis of information from the state detection apparatus.

10. The architecture diagnosis apparatus according to claim 9, wherein
the controller usual keeps driving of the state detection sensor in a stopped state, and
the controller drives the state detection sensor in a case where it is determined that the voltage by power generation of the power supp exceeds the first threshold.

11. The architecture diagnosis apparatus according to claim 9, wherein
the controller controls the power supp, usual interrupts supping of the power to the state detection sensor, and in a case where it is determined that the voltage by power generation of the power supp exceeds the first threshold, the controller starts supping of the power to the state detection sensor.

12. The architecture diagnosis apparatus according to claim 9, further comprising: a voltage sensor that measures a voltage by power generation of the power supp, wherein
the controller determines that the voltage by the power generation of the power supp exceeds the first threshold on a basis of a measurement result of the voltage sensor.

13. The architecture diagnosis apparatus according to claim 9, wherein
the controller detects change in the voltage by the power generation of the power supp as the state of the architecture in a case where the voltage by the power generation of the power supp is lower than the first threshold.

14. The state detection apparatus according to claim 1, wherein
the power supp comprises vibration power generating elements, wherein
the vibration power generating elements are respective provided at positions where the vibration power generating elements receive vibration in two directions which are orthogonal at inspection positions.

15. The state detection apparatus according to claim 1, wherein
the power supp comprises vibration power generating elements, and
the vibration power generating elements are respective provided at positions where the vibration power generating elements receive vibration in three directions which are orthogonal to one another at inspection positions.
